(19) United States
(12) Patent Application Publication
(10) Pub. No.: US 2026/0320771 A1
(43) Pub. Date: Oct. 15, 2026

(54) DISENTANGLEMENT OF OVERLAPPING GLOBAL PEAKS IN A SPECTRAL IMAGE VIA UNION OF LOCAL PEAKS FROM IMAGE SEGMENTATION

(71) Applicant: FEI Company, Hillsboro, OR (US)

(72) Inventors: Ioannis Iatrakis, Utrecht (NL); Debraj Sengupta, Eindhoven (NL)

(21) Appl. No.: 19/179,198

(22) Filed: Apr. 15, 2025

(51) Int. Cl. G06T 7/00; G01N 23/2257; G01N 23/2258; G06T 7/11; G06T 7/174; G06T 7/32

(52) U.S. Cl. CPC G06T 7/001; G01N 23/2257; G01N 23/2258; G06T 7/11; G06T 7/174; G06T 7/32; G01N 2223/6116; G06T 2207/10061; G06T 2207/30148

(57) ABSTRACT

Systems/techniques are provided for facilitating disentanglement of overlapping global peaks in a spectral image via union of local peaks from image segmentation. In various embodiments, a system can cause a charged-particle microscope to scan a specimen, thereby yielding a spectral image of the specimen and a non-spectral image of the specimen. In various aspects, the system can apply image segmentation to the non-spectral image, thereby decomposing the non-spectral image into a plurality of segmented regions. In various instances, the system can apply, for each of the plurality of segmented regions, characteristic peak matching to energy spectra respectively indicated by pixels of the spectral image that are masked by that segmented region, thereby yielding a plurality of local chemical composition indicators. In various cases, the system can generate a global chemical composition indicator for the specimen, by taking a union of the plurality of local chemical composition indicators.

### BACKGROUND

When given a spectral image of a specimen, determining a chemical composition of the specimen can be non-trivial.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate disentanglement of overlapping global peaks in a spectral image via union of local peaks from image segmentation are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an access component that can access a spectral image and at least one non-spectral image of a specimen captured by a charged-particle microscope. In various aspects, the computer-executable components can comprise a composition component that can generate a global chemical composition indicator for the specimen, based on a union of a plurality of local chemical composition indicators derived from the spectral image and from the at least one non-spectral image.

According to one or more embodiments, a computer-implemented method is provided. In various embodiments, the computer-implemented method can comprise accessing, by a device operatively coupled to a processor, a spectral image and at least one non-spectral image of a specimen captured by a charged-particle microscope. In various aspects, the computer-implemented method can comprise generating, by the device, a global chemical composition indicator for the specimen, based on a union of a plurality of local chemical composition indicators derived from the spectral image and from the at least one non-spectral image.

According to one or more embodiments, a computer program product for facilitating disentanglement of overlapping global peaks in a spectral image via union of local peaks from image segmentation is provided. In various embodiments, the computer program product can comprise a non-transitory computer-readable memory having program instructions embodied therewith. In various aspects, the program instructions can be executable by a processor to cause the processor to cause a charged-particle microscope to scan a specimen, thereby yielding a spectral image of the specimen and at least one non-spectral image of the specimen. In various instances, the program instructions can be executable to cause the processor to apply image segmentation to the at least one non-spectral image, thereby decomposing the at least one non-spectral image into a plurality of segmented regions. In various cases, the program instructions can be executable to cause the processor to apply, for each of the plurality of segmented regions, characteristic peak matching to energy spectra respectively indicated by pixels of the spectral image that are masked by that segmented region, thereby yielding a plurality of local chemical composition indicators. In various aspects, the program instructions can be executable to cause the processor to generate a global chemical composition indicator for the specimen, by taking a union of the plurality of local chemical composition indicators.

### DESCRIPTION OF THE DRAWINGS

Various embodiments will be readily understood by the following detailed description in conjunction with the accompanying figures. To facilitate this description, like reference numerals designate like structural elements. Embodiments are illustrated by way of example, not by way of limitation, in the figures. The figures are not necessarily drawn to scale.

FIG. 1 illustrates an example, non-limiting block diagram of a scientific instrument module in accordance with various embodiments described herein.

FIG. 2 illustrates an example, non-limiting flow diagram of a computer-implemented method in accordance with various embodiments described herein.

FIG. 3 illustrates a block diagram of an example, non-limiting system that facilitates disentanglement of overlapping global peaks in a spectral image via union of local peaks from image segmentation in accordance with one or more embodiments described herein.

FIG. 4 illustrates a block diagram of an example, non-limiting system including a spectral image and a set of non-spectral images that facilitates disentanglement of overlapping global peaks in a spectral image via union of local peaks from image segmentation in accordance with one or more embodiments described herein.

FIGS. 5-7 illustrate example, non-limiting block diagrams showing how a spectral image and a set of non-spectral images can be obtained in accordance with one or more embodiments described herein.

FIG. 8 illustrates a block diagram of an example, non-limiting system including a plurality of segmented regions that facilitates disentanglement of overlapping global peaks in a spectral image via union of local peaks from image segmentation in accordance with one or more embodiments described herein.

FIG. 9 illustrates an example, non-limiting block diagram showing how a plurality of segmented regions can be obtained in accordance with one or more embodiments described herein.

FIG. 10 illustrates a block diagram of an example, non-limiting system including a plurality of local chemical composition indicators and a global chemical composition indicator that facilitates disentanglement of overlapping global peaks in a spectral image via union of local peaks from image segmentation in accordance with one or more embodiments described herein.

FIGS. 11-15 illustrate example, non-limiting block diagrams showing how a global chemical composition indicator can be obtained from a plurality of local chemical composition indicators in accordance with one or more embodiments described herein.

FIGS. 16-24 illustrate example, non-limiting experimental results in accordance with one or more embodiments described herein.

FIG. 25 illustrates a block diagram of an example, non-limiting operating environment in which one or more embodiments described herein can be facilitated.

FIG. 26 illustrates an example networking environment operable to execute various implementations described herein.

FIG. 27 illustrates an example dual beam microscope that can be implemented in accordance with various embodiments described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Various operations can be described as multiple discrete actions or operations in turn, in a manner that is most helpful in understanding the subject matter disclosed herein. However, the order of description should not be construed as to imply that these operations are necessarily order dependent. In particular, these operations can be performed in an order different from the order of presentation. Operations described can be performed in a different order from the described embodiments. Various additional operations can be performed, or described operations can be omitted in additional embodiments.

Although some elements may be referred to in the singular (e.g., “a processing device”), any appropriate elements may be represented by multiple instances of that element, and vice versa. For example, a set of operations described as performed by a processing device may be implemented with different ones of the operations performed by different processing devices. As used herein, the phrase “based on” should be understood to mean “based at least in part on,” unless otherwise specified.

A charged-particle microscope (e.g., a scanning electron microscope (SEM), a transmission electron microscope (TEM), a dual beam microscope, an electron energy-loss microscope (EELM), an energy dispersive spectroscopy microscope (EDSM)) can be any suitable computerized device that can capture or generate microscopic or nanoscopic images of specimens in a scientific, laboratory, research, or clinical operational environment. To facilitate the capture or generation of such images, charged-particle microscopes can leverage complex arrangements of actuatable parts (e.g., ion sources, electron sources, optical lenses or apertures, optical plates or deflectors, columns, coils, heaters, coolers, fluid valves, fluid pumps, circuit switches, specimen stages), sensors (e.g., ion detectors, electron detectors, voltmeters, thermistors, potentiometers, pressure gauges), or consumables (e.g., carrier fluids, calibrants, filters, reactive gases).

Some charged-particle microscopes (e.g., SEMs, TEMs, dual beam microscopes) can capture non-spectral images of specimens. A non-spectral image can be an array of pixels that depict a specimen, where each pixel represents one respective intensity value (e.g., a measured Hounsfield unit value).

Some charged-particle microscopes (e.g., EELMs, EDSMs) can capture spectral images of specimens. A spectral image can be an array of pixels that depict a specimen, but instead of each pixel representing one respective intensity value, each pixel can instead represent a respective energy spectrum. In other words, each pixel can have a plurality of measured intensities or counts that are distributed across a range of defined energy bins. In still other words, a charged-particle microscope that generates a spectral image of a specimen can be considered as counting, for each of those defined energy bins, how many charged-particle events (e.g., ion strikes, X-ray emissions) belonging to that bin occurred on the specimen at the location of each pixel.

Some charged-particle microscopes can be designed or configured to capture both spectral images and non-spectral images of specimens.

In any case, when given a spectral image of a specimen (e.g., of an integrated circuit chip, of a semiconductor wafer, of a lamella, of a biological or organic sample), it can be desired to determine or evaluate a chemical composition of the specimen by analyzing the energy spectra stored in the pixels of that given spectral image. In particular, existing techniques facilitate such determination or evaluation via characteristic peak matching. Indeed, different chemical species or elements can be known or expected to exhibit spectral peaks at or in respective energy bins. Such known or expected spectral peaks can be referred to as characteristic peaks. So, for each particular peak in a measured or captured energy spectrum, characteristic peak matching can involve identifying which chemical species or element is known or expected to exhibit a characteristic peak in the same energy bin as the particular peak. Such identified chemical species can thus be considered as being present in the specimen. Additionally, an absolute or relative abundance of that identified chemical species within the specimen can be indicated by the intensity (e.g., height) of the particular peak. In this way, characteristic peak matching allows for the chemical composition (e.g., constituent chemical species present in respective amounts) of the specimen to be determined.

Note that existing techniques do not perform characteristic peak matching on the energy spectrum of each individual pixel in the given spectral image. Instead, existing techniques add all of the pixel-wise energy spectra into a single superset energy spectrum for the entirety of the given spectral image and then apply characteristic peak matching to that single superset energy spectrum. One reason for forming that single superset energy spectrum is because the signal-to-noise ratio of the energy spectrum of an individual pixel is far too low to confidently or reliably identify characteristic peaks. In other words, actual peaks in the energy spectrum of the individual pixel are often hidden or otherwise disfigured beyond recognition by noise, thereby preventing the accurate performance of characteristic peak matching. Another reason for forming that single superset energy spectrum is because characteristic peak matching consumes a not-insignificant amount of time. Thus, since the given spectral image can contain tens or hundreds of thousands of pixels, performing characteristic peak matching for each individual pixel in the given spectral image could consume an excessive amount of time (e.g., possibly hours), unless highly parallelized processing were implemented. Therefore, existing techniques teach that performing characteristic peak matching on the single superset energy spectrum decreases noise and saves time.

Unfortunately, as the inventors of various embodiments described herein realized, such existing techniques nevertheless suffer from various technical problems. Specifically, although forming a single superset energy spectrum for the entirety of the given spectral image helps to prevent noise from disfiguring spectral peaks, the present inventors noticed that such formation inadvertently causes the spectral peaks of scarce chemical species (e.g., hafnium, tantalum, or other elements present in masses or concentrations below any suitable threshold) in the specimen to be hidden or drowned out by those of plentiful chemical species (e.g., silicon, copper, or other elements present in masses or concentrations above any suitable threshold) in the specimen. Thus, performing characteristic peak matching on that single superset energy spectrum can successfully identify the plentiful chemical species but cannot do so for the scarce chemical species. In other words, existing techniques for performing characteristic peak matching can miss or ignore chemical elements in the specimen that are scarce or otherwise present in only small amounts or proportions.

Accordingly, systems or techniques that can allow chemical composition of a specimen to be determined or evaluated from a spectral image without the peaks of scarce species being drowned out by the peaks of plentiful species can be desirable.

Various embodiments described herein can address this technical problem. One or more embodiments described herein can include systems, computer-implemented methods, apparatus, or computer program products that can facilitate disentanglement of overlapping global peaks in a spectral image via union of local peaks from image segmentation. In other words, the present inventors realized that the likelihood of scarce-species peaks being drowned out or hidden by plentiful-species peaks can be significantly reduced by breaking a spectral image up into disjoint regions, each of which can be subject to characteristic peak matching independently.

In particular, various embodiments described herein can involve capturing not just a spectral image of a specimen but also a non-spectral image of the specimen. In various aspects, image segmentation can be applied to the non-spectral image, thereby breaking it up into a plurality of regions, each region being a group or collection of pixels that visually look or appear to be similar or otherwise physically related to each other. Because how a pixel visually appears in the non-spectral image can depend upon the specific chemical composition of the specimen at that pixel, each segmented region can be considered as being made up of pixels that all share the same or similar chemical composition as each other. Thus, some segmented regions can be made up predominantly of plentiful species, whereas other segmented regions can be made up predominantly of scarce species. Additionally, because the spectral image and the non-spectral image can be registered or aligned with each other, each segmented region of the non-spectral image can be considered as masking, overlaying, or otherwise corresponding in one-to-one fashion to respective pixels of the spectral image. Now, rather than reducing impact of noise by creating a single superset energy spectrum for the entirety of the spectral image, various embodiments described herein can instead reduce the impact of noise by creating a respective superset energy spectrum for each segmented region (e.g., by summing together the energy spectra of whatever pixels are masked by that segmented region). In various instances, characteristic peak matching can be independently performed on each of those region-specific superset energy spectra, thereby independently identifying the chemical composition of each segmented region. In various cases, the chemical composition of the entire specimen can then be obtained by taking the union of all those independently identified region-specific chemical compositions. Because image segmentation can cause certain segmented regions to be composed primarily of scarce species, the peaks of those scarce species can be conspicuous, unhidden, or otherwise not drowned out in the superset energy spectra that correspond to those certain segmented regions. Thus, those scarce species can be easily identified via characteristic peak matching, and such identifications can accordingly be included in the global union. By leveraging image segmentation to break up the entire (e.g., global) spectral image into the plurality of segmented (e.g., local) regions, performing characteristic peak matching independently for each segmented region, and then taking a union of the resultant region-wise chemical compositions, scarce species in the specimen can be confidently or reliably identified. Contrast this with existing techniques that cannot confidently or reliably identify scarce species.

Various embodiments described herein can be considered as a computerized tool (e.g., any suitable combination of computer-executable hardware or computer-executable software) that can facilitate disentanglement of overlapping global peaks in a spectral image via union of local peaks from image segmentation. In various aspects, such computerized tool can comprise an access component, a scan component, a segmentation component, or a composition component.

In various embodiments, there can be a charged-particle microscope. In various aspects, the charged-particle microscope can exhibit any suitable design or construction (e.g., can be an SEM, can be a TEM, can be a dual-beam microscope, can be an EELM, can be an EDSM). In various instances, there can be any suitable specimen (e.g., semiconductor wafer or lamella) that is loaded in the charged-particle microscope (e.g., that is currently located or positioned on an actuatable stage of the charged-particle microscope).

In various cases, it can be desired to identify a chemical composition of the specimen. As described herein, the computerized tool can facilitate such identification.

In various embodiments, the access component of the computerized tool can electronically access the charged-particle microscope. For instance, the access component can send electronic commands to, or can receive electronic data from, the charged-particle microscope. In some cases, the access component can be considered as a conduit through which other components of the computerized tool can electronically interact with (e.g., activate, deactivate, read, write, edit, copy, manipulate) the charged-particle microscope.

In various embodiments, the scan component of the computerized tool can electronically cause the charged-particle microscope to scan the specimen, thereby yielding a spectral image and a non-spectral image of the specimen. In other words, the scan component can electronically instruct or command the charged-particle microscope to generate the spectral image and the non-spectral image. In various instances, the scan component can cause the charged-particle microscope to perform such scanning according to any suitable microscopy protocols (e.g., default microscopy protocols with default beam currents or beam voltages; or user-selected microscopy protocols with user-selected beam currents or beam voltages).

In various aspects, the spectral image can be a three-dimensional array, where two dimensions of such array represent pixels that collectively depict or illustrate the specimen, and where a third dimension of such array represents pixel-wise energy spectra recorded by the charged-particle microscope. As a non-limiting example, the spectral image can be an a-by-b-by-c array, for any suitable positive integers a, b, and c. In such case, the spectral image can be considered as comprising a total of ab pixels, and each of those pixels can be considered as having a respective distribution across c energy bins (e.g., these c energy bins can be sized according to any suitable electron-volt (eV) resolution that is supported by the detectors of the charged-particle, so as to achieve any suitable level of energy level or energy-loss granularity). In other words, each pixel can be considered as representing or demarcating a unique two-dimensional location on the specimen, and the charged-particle microscope can count or measure: in the case of EELM, how many incident ions (e.g., electrons) emitted by the charged-particle and belonging to each of those c energy bins impacted the specimen at each of those unique two-dimensional locations; or, in the case of EDSM, how many X-rays belonging to each of those c energy bins were emitted by the specimen from each of those unique two-dimensional locations.

In various instances, the non-spectral image can be a two-dimensional pixel array that depicts or illustrates the specimen, where each pixel can contain or store a single intensity value. In various cases, the non-spectral image can be aligned (e.g., via any suitable image registration technique) with the spectral image. As a non-limiting example, if the pixels of the spectral image are arranged as an a-by-b array, the non-spectral image can likewise be an a-by-b pixel array, such that whatever portion of the specimen that is depicted by a pixel located in a particular row and particular column of the non-spectral image can likewise be considered as being represented by a pixel in the same particular row and same particular column of the spectral image. Note how the pixels of the non-spectral image can thus be considered as masking, overlaying, or otherwise respectively corresponding to those of the spectral image.

In various embodiments, the segmentation component of the computerized tool can electronically decompose the non-spectral image into a plurality of segmented regions. In various aspects, the segmentation component can accomplish such decomposition via any suitable image segmentation technique (e.g., deep learning segmentation; K-means clustering; pixel intervalling). In any case, each of the plurality of segmented regions can be considered as a collection of pixels that visually appear to be similar to each other. That is, each segmented region can be a group of pixels from the non-spectral image that have the same or similar intensity values as each other. Note that pixels which represent point-locations of the specimen that are composed of the same or similar materials or chemical elements as each other can have intensity values that are the same or similar as each other (e.g., if two point-locations of the specimen are both composed mainly of silicon, whatever two pixels of the non-spectral image that respectively correspond to those two point-locations can exhibit similar or close intensity values). In contrast, pixels that instead represent point-locations of the specimen that are composed of different or dissimilar materials or chemical elements than each other can have intensity values that are different or dissimilar to each other (e.g., if one point-location of the specimen is composed mainly of silicon while another point-location of the specimen is composed mainly of hafnium, whatever two pixels of the non-spectral image that respectively correspond to those two point-locations can exhibit different or far-apart intensity values). Accordingly, for any given segmented region, the pixels belonging to that given segmented region can be likely to have the same or similar chemical compositions as each other (e.g., can be likely to be composed of the same or similar chemical elements combined in the same or similar proportions as each other).

In various embodiments, the composition component of the computerized tool can electronically generate a plurality of local chemical composition indicators based on the plurality of segmented regions. In various aspects, the composition component can accomplish such generation via region-wise performance of characteristic peak matching. More specifically, because the non-spectral image can be aligned with the spectral image, each given segmented region of the non-spectral image can be considered as masking, overlaying, or otherwise demarcating respective pixels in the spectral image. Additionally, each of those respective pixels of the spectral image can exhibit its own respective energy spectrum. Accordingly, in various instances, the composition component can create a superset energy spectrum for that given segmented region, by adding together (e.g., in energy-bin-wise fashion) the energy spectra exhibited by whatever pixels of the spectral image are masked by that given segmented region and by ignoring any pixels of the spectral image that are not masked by that given segmented region. In various cases, the composition component can perform characteristic peak matching on that superset energy spectrum, thereby yielding a chemical composition indicator for the given segmented region. In particular, that superset energy spectrum can exhibit any suitable number of peaks, each peak being located at a respective energy bin. For each given peak, the composition component can consult any suitable library or database in search of a chemical species that is known to exhibit a characteristic peak at whichever energy bin at which the given peak is located. Such identified chemical species can thus be considered as being present within the given segmented region. Moreover, in some instances, the composition component can subsequently estimate an absolute or relative abundance of that identified chemical species within the given segmented region, based on the height or area-under-curve of the given peak (e.g., by comparing the height or area-under-curve of the given peak to calibration curves that link height or area to explicit concentrations or masses). After each peak in that superset energy spectrum has been identified, whatever piece of electronic data indicates the identified chemical species can be referred to or otherwise considered as the local chemical composition indicator of the given segmented region. In this way, the composition component can generate a respective local chemical composition indicator for each of the plurality of segmented regions, thereby yielding the plurality of local chemical composition indicators.

In various aspects, the composition component can electronically generate a global chemical composition indicator for the specimen, based on the plurality of local chemical composition indicators. In particular, the global chemical composition indicator can be equal to or otherwise based on a union of the plurality of local chemical composition indicators. In other words, if a chemical species is determined to be present in any of the plurality of segmented regions, then that chemical species can be deemed present within the specimen as a whole, and such presence can be indicated or specified in the global chemical composition indicator. Additionally, if a particular chemical species is present in multiple segmented regions, then its total or global abundance throughout the specimen can be equal to the sum of its local abundances in each of those multiple segmented regions.

In various embodiments, the composition component can electronically render the global composition indicator on any suitable electronic screen or display. In other embodiments, the composition component can electronically transmit or share the global composition indicator to or with any other computing device.

Various embodiments described herein can be employed to use hardware or software to solve problems that are highly technical in nature (e.g., to facilitate disentanglement of overlapping global peaks in a spectral image via union of local peaks from image segmentation), that are not abstract and that cannot be performed as a set of mental acts by a human. Further, some of the processes performed can be performed by a specialized computer (e.g., electron microscopes such as SEMs, TEMs, EELMs, or dual-beam microscopes) for carrying out defined acts related to the field of charged-particle microscopy.

For example, such defined acts can include: accessing, by a device operatively coupled to a processor, a spectral image and at least one non-spectral image of a specimen captured by a charged-particle microscope; and generating, by the device, a global chemical composition indicator for the specimen, based on a union of a plurality of local chemical composition indicators derived from the spectral image and from the at least one non-spectral image. In various aspects, the spectral image and the at least one non-spectral image can be aligned with each other, such that pixels of at least one non-spectral image mask respective pixels of the spectral image. In various instances, such defined acts can further include applying, by the device, image segmentation to the at least one non-spectral image, thereby decomposing the at least one non-spectral image into a plurality of segmented regions. In various cases, a first local chemical composition indicator in the plurality of local chemical composition indicators can correspond to a first segmented region in the plurality of segmented regions, and the device can generate the first local chemical composition indicator based on applying characteristic peak matching to energy spectra respectively indicated by pixels of the spectral image that are masked by the first segmented region and without regard to energy spectra respectively indicated by pixels of the spectral image that are not masked by the first segmented region. In particular, the device can apply the characteristic peak matching to a superset spectrum collectively formed by the energy spectra respectively indicated by the pixels of the spectral image that are masked by the first segmented region.

Such defined acts are inherently computerized. Indeed, a charged-particle microscope (e.g., SEM, TEM, EELM, EDSM, dual beam microscope) is a highly-technical computerized device comprising specific computerized hardware (e.g., temperature sensors, pressure sensors, voltage sensors, ion beam emitters, electron beam emitters, focusing lenses, ion detectors, electron detectors, beam apertures, fluid valves, actuatable specimen stages). A charged-particle microscope and the spectral or non-spectral images that it captures cannot be implemented by the human mind, or by a human with pen and paper, in any reasonable or practicable way without computers. Furthermore, electronically identifying chemical species from a spectral image is an inherently computer-centric task that focuses on enabling computers to automatically infer chemical composition from the energy spectra exhibited by the pixels of the spectral image. It would make no sense whatsoever to discuss spectral-image-based identification of chemical composition outside of a computerized context.

Moreover, various embodiments described herein can integrate into a practical application various teachings relating to the field of charged-particle microscopy. As explained above, when given a spectral image of a specimen, it can be desired to identify the chemical composition of the specimen via characteristic peak matching. When existing techniques are implemented, a single superset energy spectrum is formed for the entirety of the spectral image and subsequently subjected to characteristic peak matching. Existing techniques form a single superset energy spectrum for two primary reasons. First, the energy spectrum exhibited by an individual pixel of the spectral image invariably has an excessively low signal-to-noise ratio. In contrast, the single superset energy spectrum has a much higher signal-to-noise ratio, since pixel-level noise can be considered as being aggregated away. Second, performing characteristic peak matching consumes a non-zero amount of computation time. Because a spectral image can contain thousands or even millions of pixels, performing characteristic peak matching for each individual pixel would be inordinately time-consuming, unless massively parallel computing were implemented. Thus, existing techniques teach that performing characteristic peak matching on a single superset energy spectrum representing the entirety of the spectral image reduces noise and saves time. However, the present inventors realized that such existing techniques are unable to reliably identify chemical elements that are scarce or sparce (e.g., that are present in low but nevertheless not-insignificant amounts) within the specimen. Specifically, the present inventors noticed that, in the single superset energy spectrum representing the entirety of the specimen, the peaks of such scarce or sparce elements are often hidden or otherwise disfigured beyond recognition by the peaks of more plentiful elements.

Various embodiments described herein can help to ameliorate this technical problem, by implementing disentanglement of overlapping global peaks in a spectral image via union of local peaks from image segmentation. In other words, existing techniques can be considered as causing the spectral peaks of scarce elements to be tangled or overlapping with, and thus hidden by, those of plentiful elements; and the present inventors devised various embodiments described herein which disentangle or eliminate the overlap of such spectral peaks, so that the spectral peaks of scarce elements are no longer hidden by those of plentiful elements. In particular, various embodiments described herein can involve capturing not just a spectral image of a specimen, but also a non-spectral image of the specimen. Image segmentation (e.g., via machine learning, K-means clustering, or pixel intervalling) can be applied to the non-spectral image, thereby divvying it up into multiple distinct regions, with each region being a collection of pixels that look or visually appear to be similar to each other (e.g., that have similar intensity values or colors as each other). Because pixels that have similar chemical compositions as each other can look or visually appear similar to each other in the non-spectral image, such segmentation can cause each region to contain like-composition pixels. Thus, some regions will predominantly contain pixels representing plentiful or abundant elements, while other regions will predominantly contain pixels representing scarce or sparce elements. In any case, each segmented region of the non-spectral image can be considered as masking a respective portion of the spectral image. So, for each segmented region, a respective superset energy spectrum can be formed by summing together the energy spectra of whatever pixels of the spectral image are masked by that segmented region. In various aspects, characteristic peak matching can be applied independently to each of those region-wise superset energy spectra, thereby identifying the local chemical composition of each segmented region; and the global or total chemical composition of the specimen can be obtained by taking the union of all those local chemical compositions. Note that, in the superset energy spectrum of any segmented region that is predominantly composed of scarce or sparce elements, the peaks of those scarce or sparce elements can be considered as not being hidden by, overpowered by, or otherwise entangled with peaks of more plentiful elements. Thus, such scarce or sparce elements can be confidently or reliably identified as a local chemical composition via characteristic peak matching, and the above-mentioned union operator can ensure that such identified scarce or sparce elements are included in the global chemical composition of the specimen. That is, segmented-region-wise performance of characteristic peak matching as described herein can allow scarce or sparce elements to be accurately detected, unlike existing techniques.

Note that segmented-region-wise performance of characteristic peak matching as described herein can (counterintuitively, as noted in the following paragraph) be considered as satisfactorily maintaining the purported noise and time benefits of existing techniques. Indeed, when various embodiments described herein are implemented in practice, it will often be the case that each segmented region will be made up of dozens, hundreds, or even thousands of pixels. So, although the region-wise superset energy spectra described herein can exhibit signal-to-noise ratios that are not necessarily as high as that exhibited by the single, entire-image superset energy spectrum of existing techniques, the signal-to-noise ratios of such region-wise superset energy spectra can nevertheless be sufficiently high, acceptable, or otherwise more than adequate for practical purposes. Additionally, when various embodiments described herein are implemented in practice, it will often be the case that the total number or cardinality of segmented regions will be far less (e.g., many orders of magnitude less) than the total number or cardinality of pixels in the spectral image. Thus, although performing characteristic peak matching for each segmented-region-wise superset energy spectrum can consume slightly more time than would performing characteristic peak matching only for the single, image-wide superset energy spectrum of existing techniques, performing characteristic peak matching for each segmented-region-wise superset energy spectrum will nevertheless consume much less time (e.g., orders of magnitude less time) than would performing characteristic peak matching for each individual pixel. In other words, existing techniques can be considered as excelling at noise reduction and time reduction while utterly failing at scarce element detection. In stark contrast, various embodiments described herein can be considered as achieving the “best of all worlds:” reliable scarce element detection while still maintaining acceptable noise reduction and time reduction.

Additionally, the counterintuitive character of various embodiments described herein must be emphasized. Indeed, as explained above, the animating principle underlying existing techniques is that noise and computation time are reduced by performing characteristic peak matching on a single superset energy spectrum representing an entirety of a spectral image. It is not at all clear that those having ordinary skill in the art even recognized that such existing techniques suffer from the technical problem of scarce-element peaks being hidden by plentiful-element peaks. But even if those having ordinary skill in the art did recognize such technical problem (which is not conceded), they would have had no reason or motivation whatsoever to devise the herein-described embodiments. In fact, they would have been actively dissuaded from devising the herein-described embodiments. After all, rather than performing characteristic peak matching on a single superset energy spectrum representing an entire spectral image, various embodiments described herein instead perform characteristic peak matching on a respective superset energy spectrum for each segmented region of the spectral image. A person of ordinary skill in the art would have swiftly dismissed such region-wise performance of characteristic peak matching, since it would have been expected to reduce signal-to-noise ratio and increase computation time. In other words, a person of ordinary skill in the art would never have even entertained attempting the embodiments described herein, since such embodiments would have been expected to undo the benefits obtained by existing techniques. Although the present inventors have demonstrated (as explained in the above paragraph) that such expectations are unfounded in practice, such expectations nevertheless would have strongly taught against the herein-described embodiments. Accordingly, various embodiments described herein can be considered as an unusual or clever utilization of image segmentation that increases the reliability of scarce element detection and that, contrary to the expectations or teachings of existing techniques, nevertheless maintains adequate signal-to-noise ratios and computation time.

For at least the above reasons, various embodiments described herein can be considered as addressing or ameliorating various problems or disadvantages that afflict existing techniques for facilitating chemical composition identification from spectral images. Therefore, various embodiments described herein can be considered as a concrete and tangible technical improvement or technical effect in the field of charged-particle microscopy. Accordingly, various embodiments described herein certainly qualify as useful and practical applications of computers.

Furthermore, various embodiments described herein can control real-world tangible devices based on the disclosed teachings. For example, various embodiments described herein can electronically activate, deactivate, or otherwise actuate real-world hardware (e.g., ion beam emitters, ion focusing lenses, carrier fluid valves/pumps) of real-world charged-particle microscopes (e.g., SEMs, TEMs, EELMs, EDSMs, dual-beam microscopes).

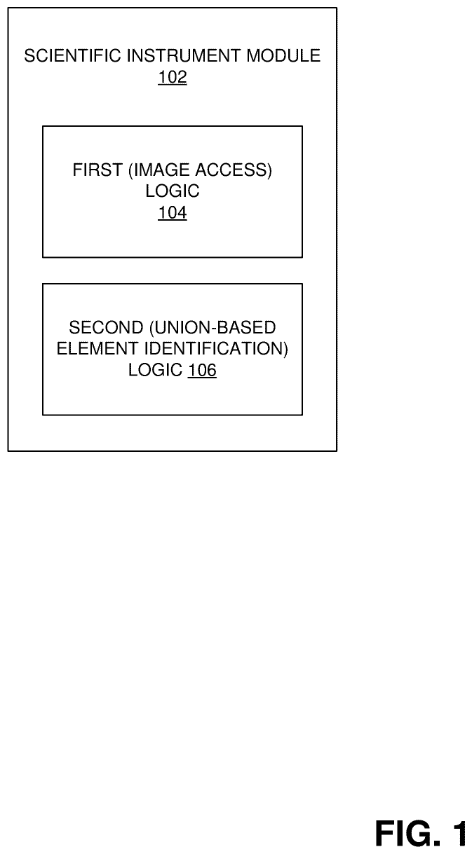

FIG. 1 illustrates an example, non-limiting block diagram of a scientific instrument module 102 in accordance with various embodiments described herein.

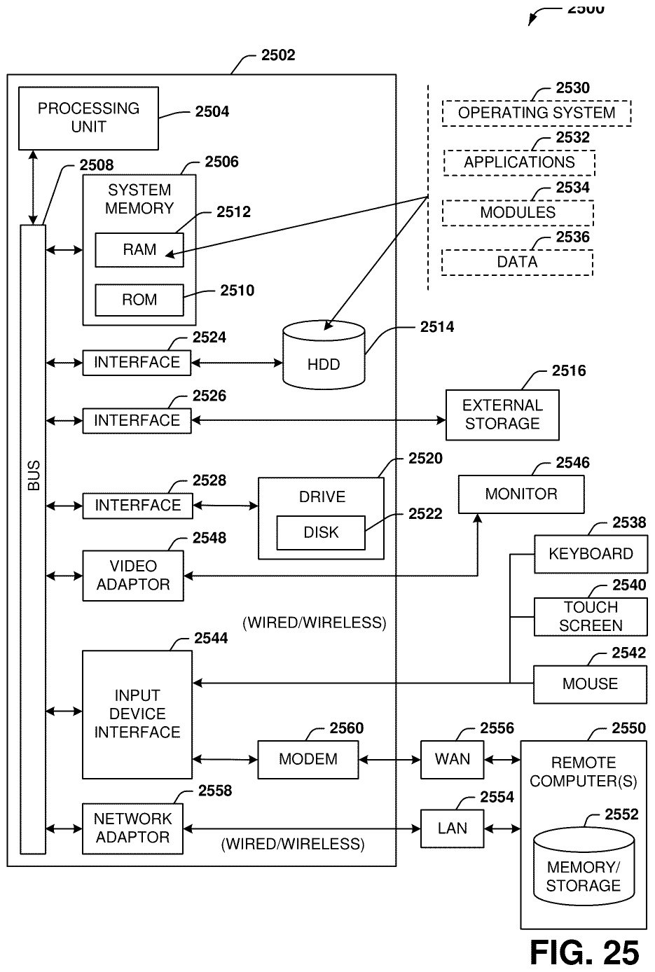

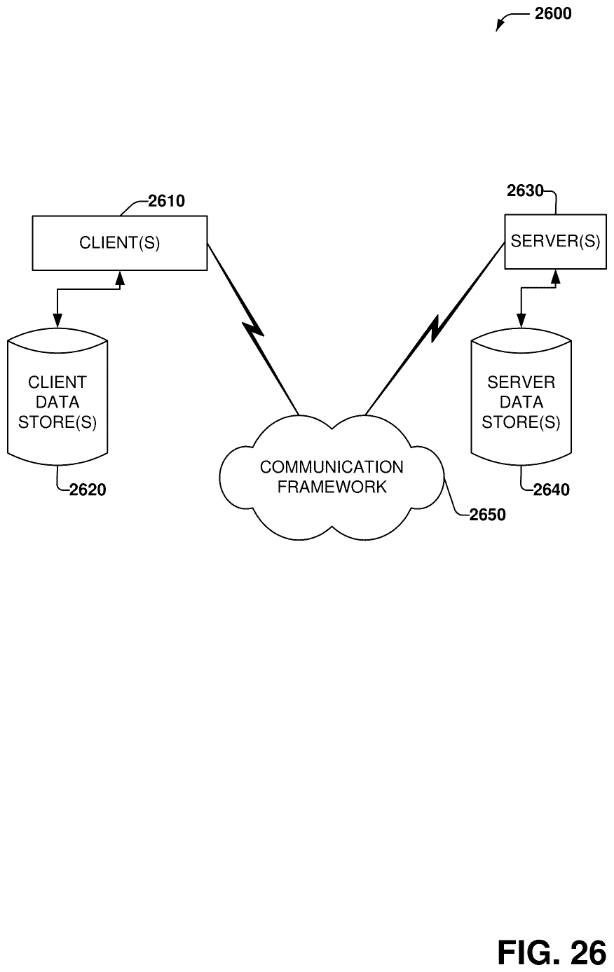

In various embodiments, the scientific instrument module 102 can be implemented by circuitry (e.g., including electrical or optical components), such as a programmed computing device. Logic of the scientific instrument module 102 can be included in a single computing device or can be distributed across multiple computing devices that are in communication with each other as appropriate. Examples of computing devices that may, singly or in combination, implement the scientific instrument module 102 are discussed herein with reference to FIG. 25, and examples of systems or networks of interconnected computing devices, in which the scientific instrument module 102 may be implemented across one or more of the computing devices, are discussed herein with reference to FIG. 26.

The scientific instrument module 102 can include first logic 104 and second logic 106. As used herein, the term “logic” can include an apparatus that is to perform a set of operations associated with the logic. For example, any of the logic elements included in the scientific instrument module 102 can be implemented by one or more computing devices programmed with instructions to cause one or more processing devices of the computing devices to perform the associated set of operations. In a particular embodiment, a logic element may include one or more non-transitory computer-readable media having instructions thereon that, when executed by one or more processing devices of one or more computing devices, cause the one or more computing devices to perform the associated set of operations. As used herein, the term “module” can refer to a collection of one or more logic elements that, together, perform a function associated with the module. Different ones of the logic elements in a module may take the same form or may take different forms. For example, some logic in a module may be implemented by a programmed general-purpose processing device, while other logic in a module may be implemented by an application-specific integrated circuit (ASIC). In another example, different ones of the logic elements in a module may be associated with different sets of instructions executed by one or more processing devices. A module can omit one or more of the logic elements depicted in the associated drawings; for example, a module may include a subset of the logic elements depicted in the associated drawings when that module is to perform a subset of the operations discussed herein with reference to that module.

In various embodiments, there can be a scientific instrument corresponding to the scientific instrument module 102. In various aspects, the scientific instrument can be any suitable computerized device that can electronically measure some scientifically-relevant, clinically-relevant, or research-relevant characteristic, property, or attribute of an analytical specimen (e.g., of a known or unknown mixture, compound, or collection of matter). As a non-limiting example, a scientific instrument can be an SEM. In such case, the scientific instrument can capture non-spectral images of the analytical specimen, so as to measure or determine a surface topography, a surface material composition, or a crystallographic structure of the analytical specimen. As another non-limiting example, a scientific instrument can be a TEM. In such case, the scientific instrument can capture non-spectral images of the interior of the analytical specimen, so as to measure or determine interior structural details of the analytical specimen. As even another non-limiting example, a scientific instrument can be a dual beam microscope. In such case, the scientific instrument can capture non-spectral images of the analytical specimen in addition to being able to mill the analytical specimen. As still another non-limiting example, the scientific instrument can be an EELM or an EDSM. In such case, the scientific instrument can capture spectral images of the analytical specimen, so as to count how many ions or X-rays belonging to respective energy bins impacted or were emitted from respective locations of the analytical specimen. As yet another non-limiting example, the scientific instrument can be any combination of any of the aforementioned types of microscopes. As a more general non-limiting example, the scientific instrument can be any suitable type of charged-particle microscope or combination of charged-particle microscopes (e.g., some types of microscopes can use beams of non-electron ions to capture spectral or non-spectral images).

In various embodiments, the first logic 104 can access a spectral image and at least one non-spectral image of any suitable analytical specimen that are captured or generated by the scientific instrument.

In various embodiments, the second logic 106 can generate a global chemical composition indicator for the analytical specimen, based on a union of a plurality of local chemical composition indicators derived from the spectral image and from the at least one non-spectral image. More specifically, the spectral image and the at least one non-spectral image can be aligned with each other, such that pixels of the at least one non-spectral image mask respective pixels of the spectral image. In various aspects, the second logic 106 can involve applying image segmentation to the at least one non-spectral image, thereby decomposing the at least one non-spectral image into a plurality of segmented regions. In various instances, each segmented region can be considered as containing multiple pixels from the at least one non-spectral image that are visually similar to each other and which thus can be assumed to represent locations of the analytical specimen that have similar (possibly not exactly the same) chemical compositions. In various cases, for each segmented region, the second logic 106 can involve generating a respective local chemical composition indicator, by applying characteristic peak matching to the energy spectra of whichever pixels of the spectral image are masked by (e.g., that are located inside of) that segmented region and by ignoring the energy spectra of pixels of the spectral image that are not masked by (e.g., that are located outside of) that segmented region. Note that, if the analytical specimen is composed of some combination of plentiful (e.g., high abundance) elements and scarce (e.g., low abundance) elements, image segmentation can be considered as forcing at least some of the segmented regions to predominantly contain pixels representing those scarce elements. Thus, when those segmented regions are evaluated independently or in isolation, the spectral peaks of those scarce elements can be conspicuously visible or otherwise not hidden by or tangled with spectral peaks of the plentiful elements. Accordingly, those scarce elements can be reliably or confidently included in at least some of the local (e.g., region-wide) chemical composition indicators, and the union operational can ensure that such scarce elements are thus included in the global (e.g., specimen-wide) chemical composition indicator.

Accordingly, the scientific instrument module 102 can facilitate disentanglement of overlapping global peaks in a spectral image via union of local peaks from image segmentation.

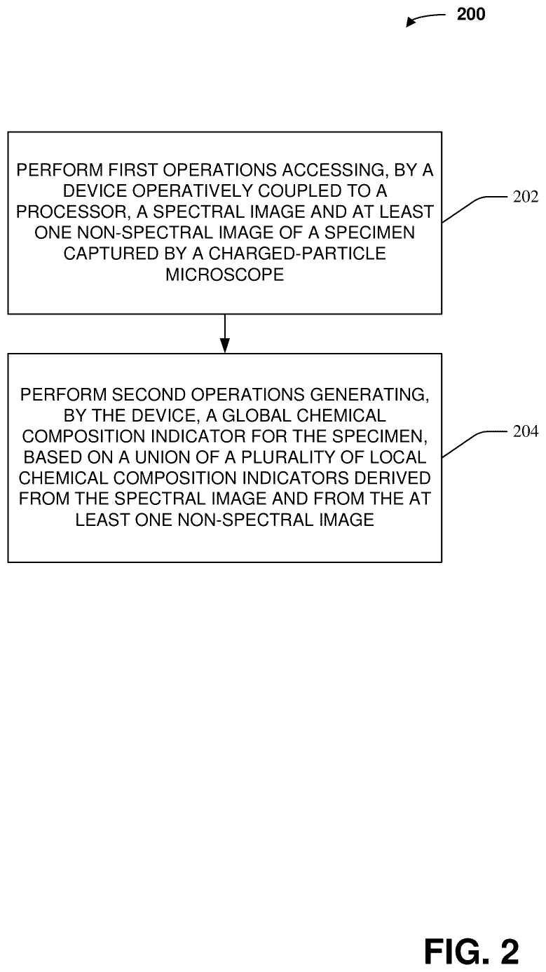

FIG. 2 is an example, non-limiting flow diagram of a computer-implemented method 200 in accordance with various embodiments described herein. The operations of the computer-implemented method 200 may be used in any suitable context to perform any suitable operations (e.g., can be performed by or used in conjunction with any of the various modules, computing devices, or graphical user interfaces described with respect to FIGS. 25-26. Operations are illustrated once each and in a particular order in FIG. 2, but the operations may be reordered or repeated as desired and appropriate (e.g., different operations performed may be performed in parallel, as suitable).

In various aspects, act 202 can include performing first operations accessing, by a device operatively coupled to a processor, a spectral image and at least one non-spectral image of a specimen captured by a charged-particle microscope. In various cases, the first logic 104 can perform or otherwise facilitate act 202.

In various aspects, act 204 can include performing second operations generating, by the device, a global chemical composition indicator for the specimen, based on a union of a plurality of local chemical composition indicators derived (e.g., via image segmentation and masking) from the spectral image and from the at least one non-spectral image. In various cases, the second logic 106 can perform or otherwise facilitate act 204.

Accordingly, the computer-implemented method 200 can facilitate disentanglement of overlapping global peaks in a spectral image via union of local peaks from image segmentation.

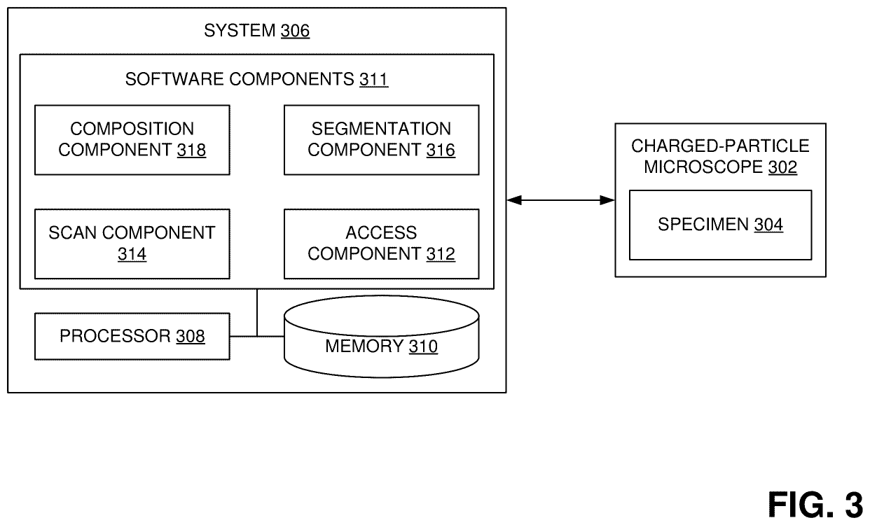

FIG. 3 illustrates a block diagram of an example, non-limiting system that can facilitate disentanglement of overlapping global peaks in a spectral image via union of local peaks from image segmentation in accordance with one or more embodiments described herein.

In various embodiments, there can be a charged-particle microscope 302. In various aspects, the charged-particle microscope 302 can be as described above. That is, the charged-particle microscope 302 can be any suitable computerized device that can leverage its constituent hardware (e.g., electron sources, anodes, condenser lenses, condenser apertures, scan coils, objective lenses, objective apertures, deflectors, condensers, stigmators, electron detectors, X-ray detectors, actuatable specimen stages) to electronically capture any suitable images of any suitable analytical specimen. As a non-limiting example, the charged-particle microscope 302 can be any suitable SEM. As another non-limiting example, the charged-particle microscope 302 can be any suitable TEM. As yet another non-limiting example, the charged-particle microscope 302 can be any suitable dual-beam microscope. As still another non-limiting example, the charged-particle microscope 302 can be any suitable EELM. As even another non-limiting example, the charged-particle microscope 302 can be any suitable EDSM. In some cases, the charged-particle microscope 302 can be any suitable combination of any of the aforementioned.

Although not explicitly shown in the figures, the charged-particle microscope 302 can be electronically integrated with any suitable human-computer interface device, which can be remote from or local to the charged-particle microscope 302. Accordingly, a user or technician associated with the charged-particle microscope 302 can interact with or otherwise control the charged-particle microscope 302. Some non-limiting examples of the human-computer interface device can be a keyboard of the charged-particle microscope 302, a keypad of the charged-particle microscope 302, a touchscreen of the charged-particle microscope 302, or a voice-command system of the charged-particle microscope 302.

Although not explicitly shown in the figures, the charged-particle microscope 302 can comprise a plurality of configurable operating settings. In various aspects, each of the plurality of configurable operating settings can be any suitable hardware-related characteristic or software-related characteristic of the charged-particle microscope 302 that can guide, affect, or otherwise dictate how the charged-particle microscope 302 runs, operates, or functions with respect to any given analytical specimen and that can be selectively controlled, changed, adjusted, or otherwise set by the user or technician (e.g., via interaction with the human-computer interface device of the charged-particle microscope 302). As a non-limiting example, any of the plurality of configurable operating settings can be a user-controllable electric voltage setting (e.g., beam voltage) or electric current setting (e.g., beam current), which can allow the user or technician to selectively control an electrode of the charged-particle microscope 302, so as to selectively increase or decrease an electric voltage or electric current within, or that is applied by, the charged-particle microscope 302. As another non-limiting example, any of the plurality of configurable operating settings can be a user-controllable temperature setting, which can allow the user or technician to control a heater (e.g., stage heater, heating coil) or cooler (e.g., cooling fan, heat pump, refrigerator) of the charged-particle microscope 302, so as to selectively increase or decrease a temperature within, or that is applied by, the charged-particle microscope 302. As still another non-limiting example, any of the plurality of configurable operating settings can be a user-controllable mechanical actuator setting, which can allow the user or technician to control a mechanical actuator (e.g., electric motor, specimen stage, iris aperture, fluid pump or syringe) of the charged-particle microscope 302, so as to selectively move the mechanical actuator. As yet another non-limiting example, any of the plurality of configurable operating settings can be a user-controllable optics setting, which can allow the user or technician to control an optical element (e.g., optical lens, optical deflector) of the charged-particle microscope 302, so as to selectively change an optical quality (e.g., focal spot size or location, astigmatism, defocus) that is applied by the charged-particle microscope 302.

In various instances, the charged-particle microscope 302 can be loaded with a specimen 304. As a non-limiting example, the specimen 304 can be presently positioned, located, or otherwise affixed onto the specimen stage of the charged-particle microscope 302, such that the specimen 304 is analyzable or scannable by the charged-particle microscope 302. In various cases, the specimen 304 can be any suitable type of synthetic sample or naturally-occurring sample that can exhibit any suitable physical, chemical, compositional, or other properties, attributes, or characteristics. In the case of synthetic specimens, the specimen 304 can be manufactured by any suitable microfabrication or nanofabrication techniques, such as etching, milling, or deposition. As a non-limiting example, the specimen 304 can be a lamella taken from a semiconductor substrate or wafer. As another non-limiting example, the specimen 304 can be any other suitable integrated circuit element or printed circuit board element. However, in the case of naturally-occurring specimens, the specimen 304 can be an organic or biological sample (e.g., a tissue sample).

In various instances, it can be desired to identify a chemical composition of the specimen 304. In other words, it can be desired to determine which elements are contained within the specimen 304 (and, optionally, to subsequently determine how much of those identified elements are contained within the specimen 304). In various cases, a system 306, which can be electronically integrated (e.g., via any suitable wired or wireless electronic connections) with the charged-particle microscope 302, can accomplish such identification or determination as described herein.

In various aspects, the system 306 can comprise a processor 308 (e.g., computer processing unit, microprocessor) and a non-transitory computer-readable memory 310 that is operably or operatively or communicatively connected or coupled to the processor 308. The non-transitory computer-readable memory 310 can store computer-executable instructions which, upon execution by the processor 308, can cause the processor 308 or other components of the system 306 (e.g., access component 312, scan component 314, segmentation component 316, composition component 318) to perform one or more acts. In various embodiments, the non-transitory computer-readable memory 310 can store computer-executable components (e.g., access component 312, scan component 314, segmentation component 316, composition component 318), and the processor 308 can execute the computer-executable components.

In various embodiments, the system 306 can comprise an access component 312. In various aspects, the access component 312 can electronically access the charged-particle microscope 302. That is, the access component 312 can electronically communicate or otherwise electronically interact with (e.g., transmit electronic instructions or commands to, receive electronic data from) the charged-particle microscope 302. Accordingly, the access component 312 can be considered as a proxy or conduit through which other components of the system 306 can interact with, communicate with, or otherwise manipulate the charged-particle microscope 302. However, these are mere non-limiting examples. In other cases, the access component 312 can be omitted, and any other components of the system 306 can communicate or interact directly with the charged-particle microscope 302.

In various embodiments, the system 306 can comprise a scan component 314. In various aspects, the scan component 314 can, as described herein, cause the charged-particle microscope 302 to capture a spectral image of the specimen 304 and at least one non-spectral image of the specimen 304.

In various embodiments, the system 306 can comprise a segmentation component 316. In various instances, the segmentation component 316 can, as described herein, break the at least one non-spectral image into a plurality of segmented regions.

In various embodiments, the system 306 can comprise a composition component 318. In various cases, the composition component 318 can, as described herein, leverage the spectral image to generate a respective local chemical composition indicator for each of the plurality of segmented regions and produce a global chemical composition indicator for the specimen 304 by taking the union of those local chemical composition indicators

Note that, in various instances, the access component 312, the scan component 314, the segmentation component 316, and the composition component 318 can collectively be considered as being one or more software components 311 of the system 306. In various aspects, it should be appreciated that the one or more software components 311 are described primarily herein as comprising four components (e.g., the access component 312, the scan component 314, the segmentation component 316, and the composition component 318) for ease of explanation and illustration. However, the one or more software components 311 are not limited to being implemented as exactly such four components in every embodiment. Indeed, in some embodiments, the functionalities described herein of such four components can be combined in any suitable fashions, so as to be implemented in or by fewer than four components (e.g., in some cases, a single component can perform all of the functionalities that are described herein with respect to the access component 312, the scan component 314, the segmentation component 316, and the composition component 318). In other embodiments, the functionalities described herein of such four components can instead be distributed, separated, split, or fragmented in any suitable fashions, so as to be implemented in or by more than four components (e.g., two or more components can facilitate the functionalities that are performable by the access component 312; two or more components can facilitate the functionalities that are performable by the scan component 314; two or more components can facilitate the functionalities that are performable by the segmentation component 316; two or more components can facilitate the functionalities that are performable by the composition component 318).

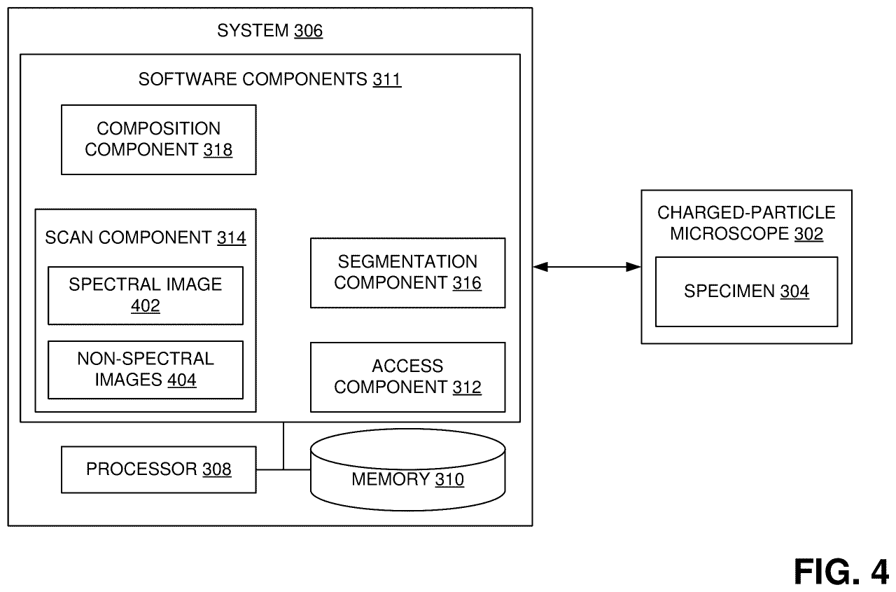

FIG. 4 illustrates a block diagram of an example, non-limiting system including a spectral image and a set of non-spectral images that can facilitate disentanglement of overlapping global peaks in a spectral image via union of local peaks from image segmentation in accordance with one or more embodiments described herein.

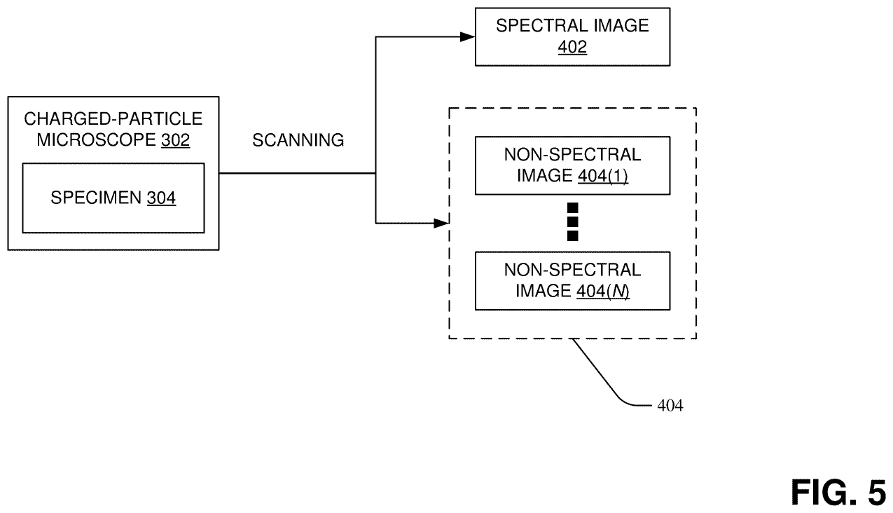

In various embodiments, the scan component 314 can electronically cause the charged-particle microscope 302 to capture or otherwise generate a spectral image 402 and a set of non-spectral images 404 of the specimen 304. Various non-limiting aspects are described with respect to FIGS. 5-7.

FIGS. 5-7 illustrate example, non-limiting block diagrams showing how the spectral image 402 and the set of non-spectral images 404 can be obtained in accordance with one or more embodiments described herein.

First, consider FIG. 5. In various embodiments, the scan component 314 can, in response to receipt or accessing of any suitable user-provided trigger or signal, electronically instruct or electronically command the charged-particle microscope 302 to scan the specimen 304.

In various aspects, such scanning can be in accordance with any suitable default microscopy protocol that is implementable by the charged-particle microscope 302 and that is known or expected to be non-destructive with respect to all, most, many, or any suitable subset of whatever population of specimens that the charged-particle microscope 302 might potentially encounter in clinical, scientific, or laboratory fields. In other words, the default microscopy protocol can be any suitable microscopy scan in which any of the configurable operating settings of the charged-particle microscope 302 are set, changed, or adjusted to any suitable default values or states that are known or expected to be safe for wide swaths of potential or possible specimens. As some non-limiting examples, the default microscopy protocol can involve a beam current setting, a beam voltage setting, and a stage temperature setting of the charged-particle microscope 302 being set, changed, or adjusted to any suitable default amperage, voltage, and temperature values that are known or expected to not damage, harm, or deteriorate most potential specimens. For instance, the beam voltage, beam current, and stage temperature of the default microscopy protocol can be set, changed, or adjusted to whatever low, threshold, or otherwise non-extreme values are widely recognized to not harm many specimens (e.g., if it is known or expected that most or many different types of specimens are not harmed by beam voltages below 10 kV, then the default microscopy protocol can have a beam voltage setting that is set to any suitable value below 10 kV; if it is known or expected that most or many different types of specimens are not harmed by beam currents below 0.1 nA, then the default microscopy protocol can have a beam current setting that is set to any suitable value below 0.1 nA; if it is known or expected that most or many different types of specimens are not harmed by stage temperatures of 300 Kelvin (K), then the default microscopy protocol can have a stage temperature setting that is set to 300 K).

In various instances, such scanning can instead be in accordance with any suitable microscopy protocol that is defined or otherwise selected by a user or technician of the charged-particle microscope 302. As a non-limiting example, the user or technician can select (e.g., via any suitable user-interface devices of the charged-particle microscope 302 or of an associated computerized workstation) any suitable values or states for any of the configurable operating settings of the charged-particle microscope 302, and the charged-particle microscope 302 can accordingly scan the specimen 304 using such selected values or states.

In any case, such scanning can yield or otherwise result in the spectral image 402 and the set of non-spectral images 404.

In various aspects, the spectral image 402 can be an x-by-y array of pixels for any suitable positive integers x and y, where each pixel can exhibit, contain, store, or otherwise indicate a respective energy spectrum that was measured or recorded by the charged-particle microscope 302 while scanning the specimen 304. Accordingly, the pixels that make up the spectral image 402 can be referred to as spectral pixels.

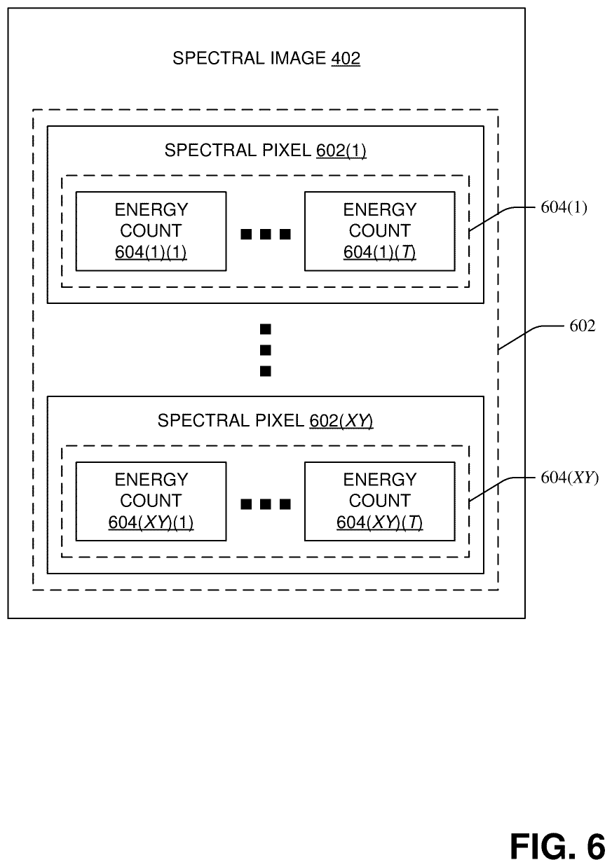

FIG. 6 shows additional non-limiting detail regarding the spectral image 402. In various aspects, the spectral image 402 can comprise a plurality of spectral pixels 602. Because the spectral image 402 can be arranged as an x-by-y array, the plurality of spectral pixels 602 can include a total of xy pixels: a spectral pixel 602(1) to a spectral pixel 602(xy). In various instances, each of the plurality of spectral pixels 602 can exhibit or contain a respective energy spectrum.

In some cases, the energy spectrum of a given spectral pixel can represent how much energy is lost by incident ions emitted from the charged-particle microscope 302 as they pass through the specimen 304. Indeed, the charged-particle microscope 302 can be configured to perform a scan on the specimen 304 by irradiating it with an incident ion beam. Accordingly, the specimen 304 can be impacted or struck by the ions of such incident beam. Now, when an ion is emitted by the charged-particle microscope 302, that ion can initially have a known amount of energy. Furthermore, when that ion impacts or strikes the specimen 304, that ion can pass through the specimen 304 and can thus lose or dissipate some of its energy. How much energy is lost or dissipated by that ion can depend upon the physical or chemical properties or characteristics (e.g., thickness, material composition, elemental concentration) of the specimen 304 at whatever location at which that ion impacted, struck, or passed through the specimen 304. In various instances, the charged-particle microscope 302 can be configured to record the quantities and energy-losses of incident ions that impact, strike, or pass through the specimen 304. In particular, there can be a total of t disjoint (e.g., non-overlapping) energy-loss bins or bands, for any suitable positive integer t (e.g., a first energy-loss bin or band can represent an energy-loss ranging from 0 eV to just below some first eV value; a second energy-loss bin or band can represent an energy-loss ranging from that first eV value to just below some second eV value that is greater than the first eV value; a third energy-loss bin or band can represent an energy-loss ranging from that second eV value to just below some third eV value that is greater than the second eV value). In various cases, the charged-particle microscope 302 can be configured to count or measure how many incident ions belonging to respective ones of those t energy-loss bins or bands strike, impact, or pass through respective physical locations on the specimen 304.

In other cases, the energy spectrum of a given spectral pixel can represent how much energy is contained by X-rays that are emitted by the specimen 304 in response to being struck by ions emitted from the charged-particle microscope 302. Indeed, as mentioned above, the charged-particle microscope 302 can be configured to perform a scan on the specimen 304 by irradiating it with an incident ion beam. Accordingly, the specimen 304 can be impacted or struck by the ions of such incident beam. Now, when a particular location of the specimen 304 is struck by an incident ion, that particular location can become energized and thereby emit or release an X-ray, where the energy level of that X-ray can depend upon the physical or chemical properties or characteristics of the specimen 304 at that particular location. In various instances, the charged-particle microscope 302 can be configured to record the quantities and energy levels of X-rays that are emitted by the specimen 304. Indeed, just as above, there can be a total of t disjoint energy bins or bands, and the charged-particle microscope 302 can be configured to count or measure how many X-rays belonging to respective ones of those t energy bins or bands are emitted from respective physical locations of the specimen 304.

As a non-limiting example, the spectral pixel 602(1) can exhibit or store an energy spectrum 604(1). In various aspects, the energy spectrum 604(1) can include a respective energy count for each of the t energy (or energy-loss) bins or bands that the charged-particle microscope 302 is configured to monitor. For instance, the energy spectrum 604(1) can include an energy count 604(1)(1), which can be a scalar whose magnitude indicates or is otherwise proportional to: how many incident ions belonging to the first energy bin or band struck, impacted, or passed through the specimen 304 at whatever specific location is represented or depicted by the spectral pixel 602(1); or how many X-rays belonging to the first energy bin or band were emitted by the specimen 304 at whatever specific location is represented or depicted by the spectral pixel 602(1). As another instance, the energy spectrum 604(1) can include an energy count 604(1)(t), which can be a scalar whose magnitude indicates or is otherwise proportional to: how many incident ions belonging to the t-th energy bin or band struck, impacted, or passed through the specimen 304 at whatever specific location is represented or depicted by the spectral pixel 602(1); or how many X-rays belonging to the t-th energy bin or band were emitted by the specimen 304 at whatever specific location is represented or depicted by the spectral pixel 602(1). Thus, the energy spectrum 604(1) can be considered as a sequence of t bin-count tuples corresponding to whatever location is represented or depicted by the spectral pixel 602(1).

As another non-limiting example, the spectral pixel 602(xy) can exhibit or store an energy spectrum 604(xy). In various aspects, the energy spectrum 604(xy) can include a respective energy count for each of the t energy (or energy-loss) bins or bands that the charged-particle microscope 302 is configured to monitor. For instance, the energy spectrum 604(xy) can include an energy count 604(xy)(1), which can be a scalar whose magnitude indicates or is otherwise proportional to: how many incident ions belonging to the first energy bin or band struck, impacted, or passed through the specimen 304 at whatever specific location is represented or depicted by the spectral pixel 602(xy); or how many X-rays belonging to the first energy bin or band were emitted by the specimen 304 at whatever specific location is represented or depicted by the spectral pixel 602(xy). As another instance, the energy spectrum 604(xy) can include an energy count 604(xy)(t), which can be a scalar whose magnitude indicates or is otherwise proportional to: how many incident ions belonging to the t-th energy bin or band struck, impacted, or passed through the specimen 304 at whatever specific location is represented or depicted by the spectral pixel 602(xy); or how many X-rays belonging to the t-th energy bin or band were emitted by the specimen 304 at whatever specific location is represented or depicted by the spectral pixel 602(xy). So, the energy spectrum 604(xy) can be considered as a sequence of t bin-count tuples corresponding to whatever location is represented or depicted by the spectral pixel 602(xy).

Referring back to FIG. 4, the set of non-spectral images 404 can include n images, for any suitable positive integer n: a non-spectral image 404(1) to a non-spectral image 404(n). In various aspects, each of the set of non-spectral images 404 can be an x-by-y array of pixels, where each pixel can exhibit, contain, store, or otherwise indicate a respective intensity value (e.g., Hounsfield unit value) that was measured or recorded by the charged-particle microscope 302 while scanning the specimen 304. Accordingly, the pixels that make up each of the set of non-spectral images 404 cannot be referred to as spectral pixels.

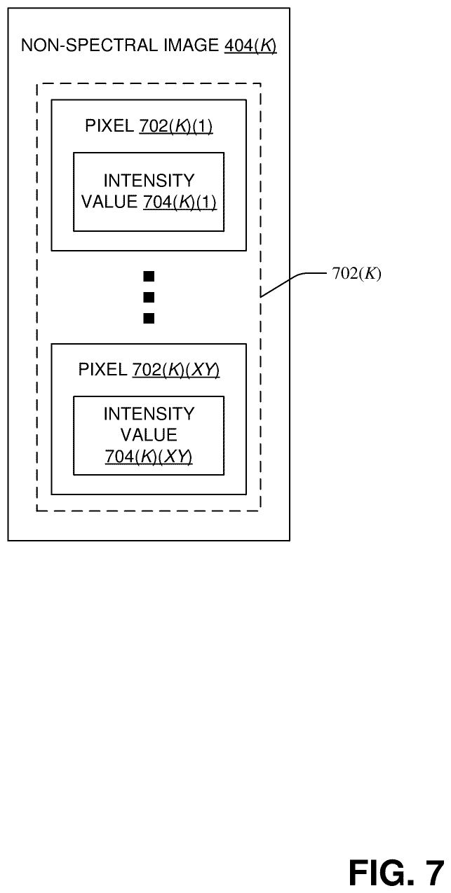

FIG. 7 shows additional non-limiting detail regarding the set of non-spectral images 404. Consider a non-spectral image 404(k) for any suitable positive integer k≤n. In various aspects, the non-spectral image 404(k) can comprise a plurality of pixels 702(k). Because the non-spectral image 404(k) can be arranged as an x-by-y array, the plurality of pixels 702(k) can include a total of xy pixels: a pixel 702(k)(1) to a pixel 702(k)(xy). Unlike the plurality of spectral pixels 602, each of the plurality of pixels 702(k) can exhibit or contain a respective intensity value. As a non-limiting example, the pixel 702(k)(1) can exhibit or contain an intensity value 704(k)(1), which can be a scalar whose magnitude indicates how much incident light or other radiation was detected by the charged-particle microscope 302 at whatever location of the specimen 304 is represented or depicted by the pixel 702(k)(1). As another non-limiting example, the pixel 702(k)(xy) can exhibit or contain an intensity value 704(k)(xy), which can be a scalar whose magnitude indicates how much incident light or other radiation was detected by the charged-particle microscope 302 at whatever location of the specimen 304 is represented or depicted by the pixel 702(k)(xy).

Note that, in various instances, the non-spectral image 404(k) can be aligned with the spectral image 402, such that they both depict or illustrate the specimen 304 from a same perspective or spatial orientation. That is, for any suitable positive integers i≤x and j≤y, whichever one of the plurality of pixels 702(k) that is positioned in an i-th row and j-th column of the non-spectral image 404(k) can be considered as depicting, illustrating, or otherwise representing the same point or location of the specimen 304 as whichever one of the plurality of spectral pixels 602 that is positioned in an i-th row and j-th column of the spectral image 402. In some cases (e.g., in situations where the charged-particle microscope 302 is a single discrete device that can capture both spectral and non-spectral images), such alignment can be achieved by virtue of the charged-particle microscope 302 scanning the specimen 304 using a single, fixed, or uniform perspective, orientation, or angle of aim. In some cases (e.g., in situations where the charged-particle microscope 302 is a combination of multiple discrete devices, one of which (such as an EELM) can capture spectral images and another of which (such as an SEM) can capture non-spectral images), such alignment can be achieved by virtue of any suitable image registration techniques. Non-limiting examples of such image registration techniques can include: point-based image registration; line-based image registration; cross-correlation image registration; mutual information image registration; sum of squared differences image registration; rigid image registration; deformable image registration; or deep learning image registration. No matter how such alignment is achieved, the non-spectral image 404(k) can be considered as masking or overlaying the spectral image 402.

Furthermore, note that each of the set of non-spectral images 404 can, in various aspects, be considered as a respective type or version of visualization of the specimen 304. For instance, each of the set of non-spectral images 404 can depict or illustrate the specimen 304 using a respective or unique type of color scheme, brightness scheme, contrast scheme, or visual texture scheme. It should be understood or otherwise appreciated that such respective or unique color schemes, brightness schemes, contrast schemes, or visual texture schemes can be achieved by setting the operating parameters of the charged-particle microscope 302 to respective or unique configurations. As a non-limiting example, a first non-spectral image in the set of non-spectral images 404 can be captured using a first operating parameter configuration (e.g., using first beam voltage, beam current, focal spot size, or raster speed values), which can cause brighter colors to depict denser materials and darker colors to depict less dense materials; whereas a second non-spectral image in the set of non-spectral images 404 can be captured using a second operating parameter configuration (e.g., using second beam voltage, beam current, focal spot size, or raster speed values), which can cause brighter colors to depict less dense materials and darker colors to depict denser materials.

From the above discussion of the non-spectral image 404(k), it should be understood or otherwise appreciated that each of the set of non-spectral images 404 can be considered as being registered or aligned with, and thus considered as masking, the spectral image 402. Furthermore, it should be understood or otherwise appreciated that each of the set of non-spectral images 404 can be considered as being registered or aligned with each other (e.g., each can depict or show a respective visualization or version of the specimen 304 from the same perspective or spatial orientation as each other).

Note that, although the total number of pixels in the set of non-spectral images 404 is xyn (e.g., xy pixels per image, with a total of n images), the set of non-spectral images 404 can be considered as defining or exhibiting a total of xy unique or distinct pixel locations, with each of the set of non-spectral images 404 indicating a respective intensity value (e.g., as measured according to whatever operating parameter configuration was used to capture that non-spectral image) for each of those xy pixel locations. For instance, for a pixel location (i, j) (e.g., i-th column and j-th row), each of the set of non-spectral images 404 can specify a respective intensity value recorded at the pixel location (i, j), thereby yielding a total of n intensity values for the pixel location (i, j). It should be understood or otherwise appreciated that any respective statistical metrics can thus be computed for the pixel location (i, j), such as mean intensity value for the pixel location (i, j) or standard deviation of intensity values for the pixel location (i, j). Note that, when hereinafter referring to the set of non-spectral images 404, the remainder of the herein disclosure will primarily be concerned with or otherwise referring to these xy pixel locations.

In any case, the scan component 314 can cause the charged-particle microscope 302 to capture or create the spectral image 402 and the set of non-spectral images 404.

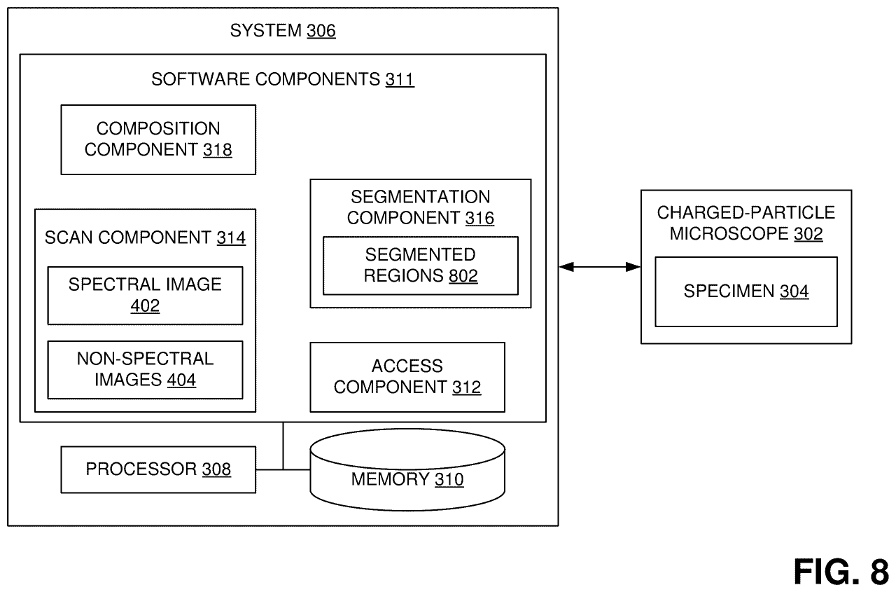

FIG. 8 illustrates a block diagram of an example, non-limiting system including a plurality of segmented regions that can facilitate disentanglement of overlapping global peaks in a spectral image via union of local peaks from image segmentation in accordance with one or more embodiments described herein.

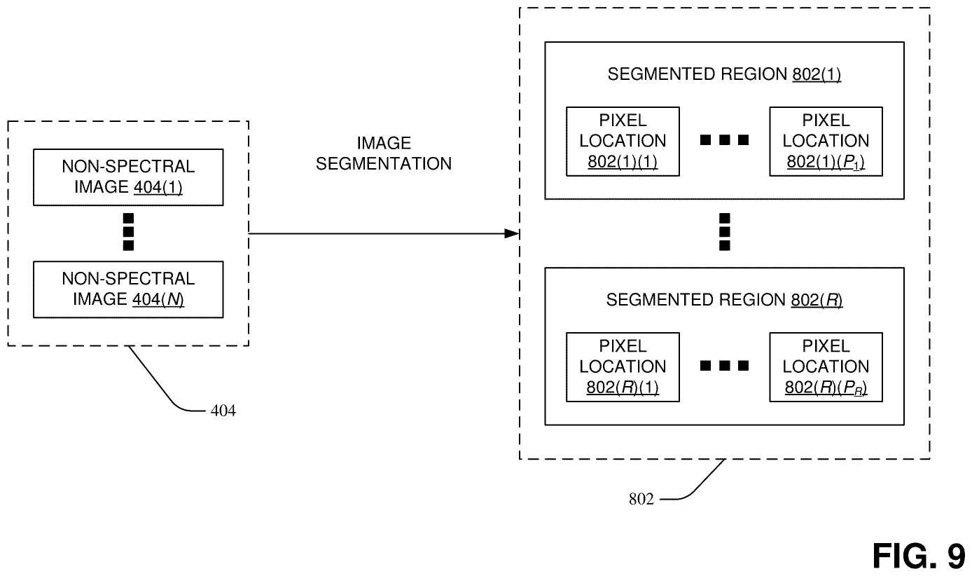

In various embodiments, the segmentation component 316 can electronically generate a plurality of segmented regions 802, based on the set of non-spectral images 404. Non-limiting aspects are described with respect to FIG. 9.

FIG. 9 illustrates an example, non-limiting block diagram showing how the plurality of segmented regions 802 can be obtained in accordance with one or more embodiments described herein.

In various embodiments, the segmentation component 316 can electronically generate the plurality of segmented regions 802 by applying any suitable image segmentation technique to the set of non-spectral images 404.

As a non-limiting example, the segmentation component 316 can apply any suitable type of deep learning image segmentation to the set of non-spectral images 404. For instance, the segmentation component 316 can electronically store, maintain, control, or otherwise access a segmentation neural network. In various aspects, the segmentation neural network can exhibit any suitable deep learning internal architecture. Indeed, in various cases, the segmentation neural network can have an input layer, one or more hidden layers, and an output layer. In various instances, any of such layers can be coupled together by any suitable interneuron connections or interlayer connections, such as forward connections, skip connections, or recurrent connections. Furthermore, in various cases, any of such layers can be any suitable types of neural network layers having any suitable learnable or trainable internal parameters. For example, any of such input layer, one or more hidden layers, or output layer can be convolutional layers, whose learnable or trainable parameters can be convolutional kernels. As another example, any of such input layer, one or more hidden layers, or output layer can be dense layers, whose learnable or trainable parameters can be weight matrices or bias values. As still another example, any of such input layer, one or more hidden layers, or output layer can be batch normalization layers, whose learnable or trainable parameters can be shift factors or scale factors. As even another example, any of such input layer, one or more hidden layers, or output layer can be LSTM layers, whose learnable or trainable parameters can be input-state weight matrices or hidden-state weight matrices. As yet another example, any of such input layer, one or more hidden layers, or output layer can be transformer layers, whose learnable or trainable parameters can be single-head or multi-head attention blocks or other weight matrices. Further still, in various cases, any of such layers can be any suitable types of neural network layers having any suitable fixed or non-trainable internal parameters. For example, any of such input layer, one or more hidden layers, or output layer can be non-linearity layers, padding layers, pooling layers, or concatenation layers.

Regardless of the specific internal architecture (e.g., the specific numbers, types, or organization of layers) that is implemented within the segmentation neural network, the segmentation neural network can be configured to perform image segmentation on inputted images. That is, the segmentation neural network can be configured to receive as input an image (or multiple images that are registered or aligned with each other) and to produce as output a segmentation mask that indicates to which one of two or more classes or categories each pixel of that inputted image (or each pixel location indicated by those multiple registered inputted images) belongs. Accordingly, in various aspects, the segmentation component 316 can execute the segmentation neural network on the set of non-spectral images 404, and such execution can cause the segmentation neural network to produce the plurality of segmented regions 802. More specifically, the segmentation component 316 can concatenate the set of non-spectral images 404 together and can feed that concatenation to the input layer of the segmentation neural network. In various aspects, that concatenation can complete a forward pass through the one or more hidden layers of the segmentation neural network. In various instances, the output layer of the segmentation neural network can compute or otherwise calculate the plurality of segmented regions 802, based on activation maps or feature maps provided by the one or more hidden layers of the segmentation neural network during the forward pass.

It should be understood or otherwise appreciated that, in order for the segmentation neural network to function correctly, it should first be trained. In various aspects, such training can be facilitated in any suitable fashion, such as in supervised fashion. For instance, prior to beginning training, the trainable internal parameters (e.g., convolutional kernels, weight matrices, bias values) of the segmentation neural network can be initialized in any suitable fashion (e.g., via random initialization). Additionally, a training dataset can be curated which contains a multitude of training inputs and a respectively corresponding multitude of ground-truth annotations (e.g., each training input can be a training image or a concatenation of registered training images; and each ground-truth annotation can be whatever ground-truth segmented regions are known or deemed to correspond to a respective training input). For any given training input, the segmentation neural network can be executed on the given training input, thereby causing the segmentation neural network to produce some output. More specifically, the given training input can be fed or routed to the input layer of the segmentation neural network, the given training input can complete a forward pass through the one or more hidden layers of the segmentation neural network, and the output layer of the segmentation neural network can compute the output based on activation maps or feature maps provided by the one or more hidden layers. Note that the format, size, or dimensionality of the output can be dictated by the number, arrangement, sizes, or other characteristics of the neurons, convolutional kernels, attention blocks, or other internal parameters of the output layer (or of any other layers) of the segmentation neural network. Accordingly, the output can be forced to have any desired format, size, or dimensionality, by adding, removing, or otherwise adjusting characteristics of the output layer (or of any other layers) of the segmentation neural network. Thus, in various aspects, the output can be considered as the predicted or inferred segmented regions (e.g., a predicted or inferred segmentation mask) that the segmentation neural network has synthesized for the given training input. Note that, if the segmentation neural network has so far undergone no or little training, then the output can be highly inaccurate. In other words, the output can be very different from the ground-truth annotation. In any case, an error (e.g., mean absolute error, mean squared error, cross-entropy error) between the output and the ground-truth annotation can be computed, and the trainable internal parameters of the segmentation neural network can be incrementally updated via backpropagation (e.g., stochastic gradient descent) based on the error. Such execution-and-update procedure can be repeated for any suitable number input-annotation pairs, which can ultimately cause the trainable internal parameters of the segmentation neural network to become iteratively optimized for accurately segmenting inputted images. It should be understood or otherwise appreciated that any suitable training batch sizes, any suitable error/loss functions, or any suitable training termination criteria can be utilized during such training. Although this non-limiting example pertains to training the segmentation neural network in supervised fashion, it should be understood or otherwise appreciated that the segmentation neural network can be trained in any other suitable fashion (e.g., in unsupervised fashion or in reinforcement learning fashion).

As another non-limiting example, rather than utilizing deep learning segmentation, the segmentation component 316 can instead apply K-means clustering to the set of non-spectral images 404 in order to generate the plurality of segmented regions 802. For instance, when given an image (or multiple images that are registered with each other), K-means clustering can involve iteratively assigning each pixel of that given image (or each pixel location indicated by those multiple registered inputted images) to one of a variable number of clusters according to the intensity value of that pixel (or according to the intensity values of that pixel location). At a beginning or initial iteration, the pixels (or pixel locations) can be assigned to the clusters randomly, and a respective centroid can be computed for each cluster. At each subsequent iteration, each pixel (or each pixel location, as appropriate) can be reassigned to whichever cluster to whose centroid the intensity value of that pixel is (or the intensity values of that pixel location are) nearest (e.g., as measured via within-cluster sum of squares), and a new centroid can be computed for each cluster after such reassignment. As more and more iterations are performed, the variance within each cluster can diminish until it is below any suitable threshold. At such point, the final or most recently formed clusters can be considered as the plurality of segmented regions 802, with each cluster being a respective one of the plurality of segmented regions 802. It should be understood or otherwise appreciated that the number of clusters employed by K-means clustering can be determined in any suitable fashion, such as via: the elbow clustering method; the silhouette clustering method, the gap statistic method; or the Davies-Bouldin index method. It should also be understood or otherwise appreciated that any variation of K-means clustering can be implemented by the segmentation component 316, such as the Jenks natural breaks variation.

As yet another non-limiting example, rather than utilizing deep learning segmentation or K-means clustering, the segmentation component 316 can instead apply pixel intervalling to the set of non-spectral images 404 in order to generate the plurality of segmented regions 802. For instance, when given an image, pixel intervalling (e.g., also referred to as intensity binning) can involve breaking up the total range or domain of intensity values that could possibly be taken on by a pixel into a plurality of intervals and grouping the pixels of the given image based on which intervals their intensity values fall into. In some aspects, those intervals can be evenly spaced (e.g., all intervals can be the same size or length as each other). In other aspects, those intervals can be unevenly spaced (e.g., some intervals can be larger or longer than others). In any case, each interval can be considered as defining or corresponding to a respective one of the plurality of segmented regions 802.

No matter which specific type of image segmentation technique is applied by the segmentation component 316 to the set of non-spectral images 404, the segmentation component 316 can be considered as breaking, dividing, or decomposing the xy distinct pixel locations represented or defined by the set of non-spectral images 404 into the plurality of segmented regions 802. In various instances, the plurality of segmented regions 802 can include r regions, for any suitable positive integer r>1: a segmented region 802(1) to a segmented region 802(r). In various cases, each of the plurality of segmented regions 802 can be a collection of pixel locations whose intensity values are similar to (e.g., within any suitable threshold margin of) each other. In other words, each of the plurality of segmented regions 802 can be a grouping of pixel locations that visually look or appear to be similar to each other within each of the set of non-spectral images 404.

As a non-limiting example, the segmented region 802(1) can contain a total of p₁ pixel locations for any suitable positive integer 1<p₁<xy: a pixel location 802(1)(1) to a pixel location 802(1)(p₁). Thus, those p₁ pixel locations can be considered as visually looking similar to each other within each of the set of non-spectral images 404 (e.g., all of those p₁ pixel locations can be a same or similar color or shade (e.g., intensely bright) within a first one of the set of non-spectral images 404; all of those p₁ pixel locations can be a same or similar color or shade (e.g., intermediately bright) within a second one of the set of non-spectral images 404; all of those p₁ pixel locations can be a same or similar color or shade (e.g., intermediately dark) within a third one of the set of non-spectral images 404; all of those p₁ pixel locations can be a same or similar color or shade (e.g., intensely dark) within a fourth one of the set of non-spectral images 404). Accordingly, there can be a high likelihood or probability that whatever physical portions of the specimen 304 are depicted or represented by those p₁ pixel locations have the same or similar chemical compositions (e.g., contain elements of the same or similar atomic weights) as each other.

As another non-limiting example, the segmented region 802(r) can contain a total of pᵣ pixel locations for any suitable positive integer 1<pᵣ<xy: a pixel location 802(r)(1) to a pixel location 802(r)(pᵣ). So, those pᵣ pixel locations can be considered as visually looking similar to each other within each of the set of non-spectral images 404. Therefore, there can be a high likelihood or probability that whatever physical portions of the specimen 304 are depicted or represented by those pᵣ pixel locations have the same or similar chemical compositions as each other.

Note that, depending upon which image segmentation technique is implemented by the segmentation component 316, any of the set of segmented regions 802 can be contiguous (e.g., a given segmented region is contiguous if and only if there exists an unbroken path between every two pixel locations that are members of the segmented region, where such unbroken path does not cross any pixel location that is not a member of that segmented region) or non-contiguous (e.g., a given segmented region is noncontiguous if the only unbroken path between any two pixel locations that are members of the segmented region crosses or traverses any pixel location that is not a member of that segmented region).

Furthermore, note that, in various aspects, the plurality of segmented regions 802 can be disjoint or non-overlapping with each other. In other words, each of the xy distinct pixel locations defined by the set of non-spectral images 404 can belong to at most one of the plurality of segmented regions 802 (e.g., such that no two segmented regions can share pixel locations).

Further still, note that, in various instances, a union of the plurality of segmented regions 802 can be equal to the xy distinct pixel locations defined by the set of non-spectral images 404. In other words, it can be the case that none of the xy distinct pixel locations defined by the set of non-spectral images 404 is not assigned to a respective segmented region (e.g., it can be the case that

$${\sum }_{i = 1}^{r} {p}_{i} = xy ) .$$

In any case, each of the plurality of segmented regions 802 can be considered as masking, overlaying, or otherwise corresponding to a respective portion of, and thus respective spectral pixels of, the spectral image 402. For instance, the segmented region 802(1) can be considered as masking a first portion of the spectral image 402 that is made up of p₁ spectral pixels (e.g., that first portion of the spectral image 402 can include whichever one of the plurality of spectral pixels 602 that is located at the pixel location 802(1)(1); that first portion of the spectral image 402 can include whichever one of the plurality of spectral pixels 602 that is located at the pixel location 802(1)(p₁)). As another instance, the segmented region 802(r) can be considered as masking an r-th portion of the spectral image 402 that is made up of pᵣ spectral pixels (e.g., that r-th portion of the spectral image 402 can include whichever one of the plurality of spectral pixels 602 that is located at the pixel location 802(r)(1); that r-th portion of the spectral image 402 can include whichever one of the plurality of spectral pixels 602 that is located at the pixel location 802(r)(pᵣ)).

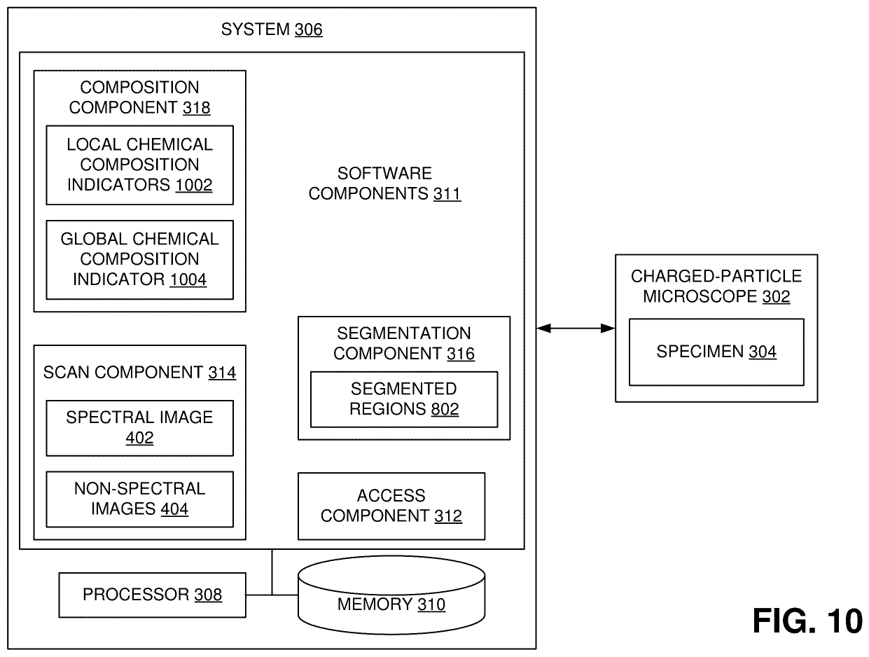

FIG. 10 illustrates a block diagram of an example, non-limiting system including a plurality of local chemical composition indicators and a global chemical composition indicator that can facilitate disentanglement of overlapping global peaks in a spectral image via union of local peaks from image segmentation in accordance with one or more embodiments described herein.

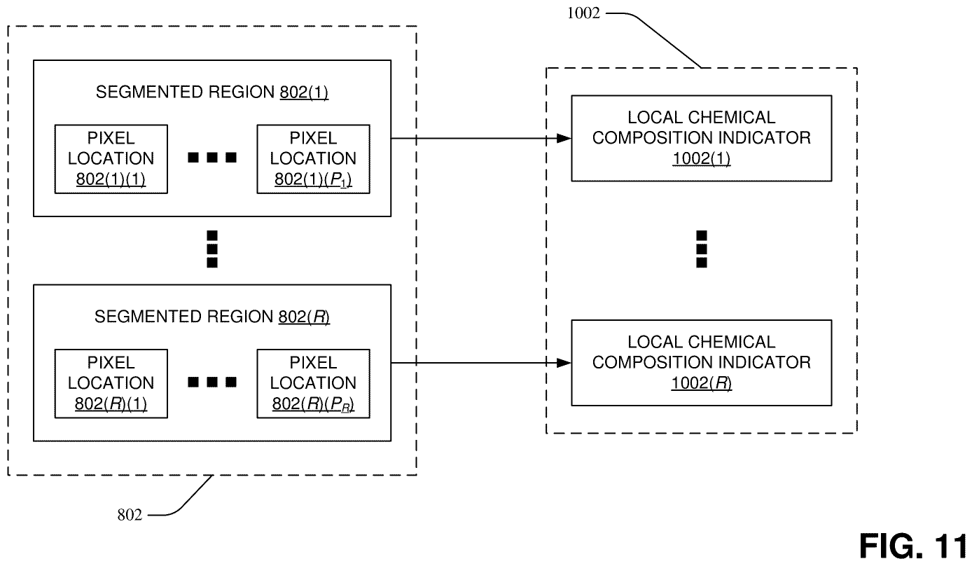

In various embodiments, the composition component 318 can electronically generate a plurality of local chemical composition indicators 1002 based on the spectral image 402 and the plurality of segmented regions 802. In various aspects, the composition component 318 can accordingly generate a global chemical composition indicator 1004 based on the plurality of local chemical composition indicators 1002. Various non-limiting aspects are described with respect to FIGS. 11-15.

FIGS. 11-15 illustrate example, non-limiting block diagrams showing how the global chemical composition indicator 1004 can be obtained from the plurality of local chemical composition indicators 1002 in accordance with one or more embodiments described herein.

First, consider FIG. 11. In various embodiments, the plurality of local chemical composition indicators 1002 can respectively correspond (e.g., in one-to-one fashion) to the plurality of segmented regions 802. So, since the plurality of segmented regions 802 can include r regions, the plurality of local chemical composition indicators 1002 can include r indicators: a local chemical composition indicator 1002(1) to a local chemical composition indicator 1002(r). In various aspects, each of the plurality of local chemical composition indicators 1002 can be any suitable piece of electronic data that identifies the chemical composition of whatever portion of the specimen 302 is depicted or illustrated by a respective one of the plurality of segmented regions 802, hence the term “local”. As a non-limiting example, the local chemical composition indicator 1002(1) can correspond to the segmented region 802(1). Thus, the local chemical composition indicator 1002(1) can be one or more scalars, one or more vectors, one or more matrices, one or more tensors, one or more character strings, or any suitable combination thereof that specifies, conveys, or otherwise represents which chemical species or elements make up or are contained within whatever physical portion of the specimen 304 that falls under or is masked by the segmented region 802(1). As another non-limiting example, the local chemical composition indicator 1002(r) can correspond to the segmented region 802(r). So, the local chemical composition indicator 1002(r) can be one or more scalars, one or more vectors, one or more matrices, one or more tensors, one or more character strings, or any suitable combination thereof that specifies, conveys, or otherwise represents which chemical species or elements make up or are contained within whatever physical portion of the specimen 304 that falls under or is masked by the segmented region 802(r).

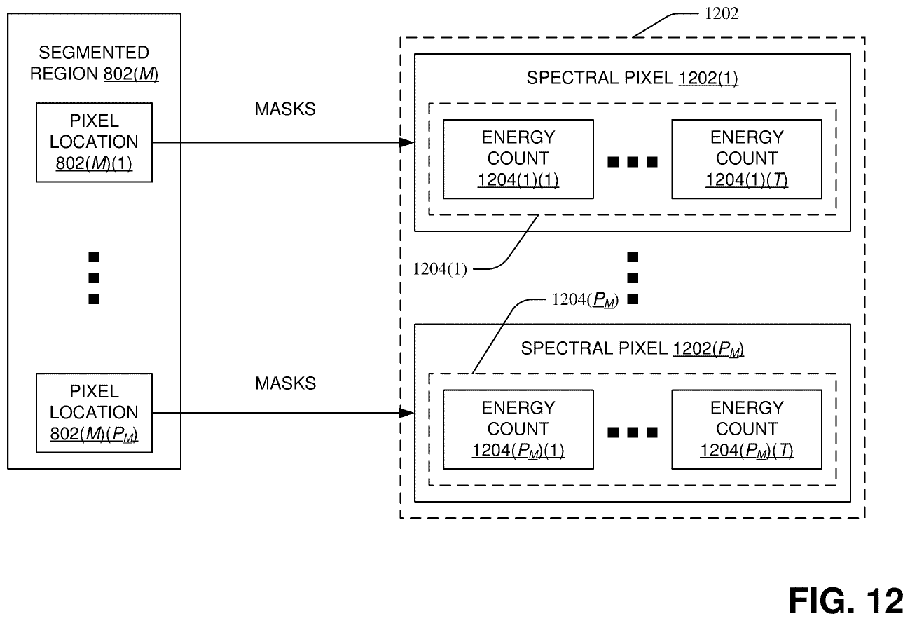

FIGS. 12-14 show non-limiting details regarding how the plurality of local chemical composition indicators 1002 can be generated.

Consider FIG. 12. In various aspects, the composition component 318 can select any one of the plurality of segmented regions 802. Such selected segmented region can be referred to as a segmented region 802(m) for any suitable positive integer m≤r. Note that the segmented region 802(m) can contain a total of pₘ pixel locations for any suitable positive integer 1<pₘ<xy: a pixel location 802(m)(1) to a pixel location 802(m)(pₘ). So, those pₘ pixel locations can be considered as visually looking similar to each other within each of the set of non-spectral images 404. Therefore, there can be a high likelihood or probability that whatever physical portions of the specimen 304 are depicted or represented by those pₘ pixel locations have the same or similar chemical compositions as each other.

In any case, each pixel location of the segmented region 802(m) can be considered as masking, overlaying, or otherwise corresponding to a respective spectral pixel of the spectral image 402.

As a non-limiting example, whichever one of the plurality of spectral pixels 602 that is masked by or positioned at the pixel location 802(m)(1) can be referred to as a spectral pixel 1202(1). Note that the spectral pixel 1202(1) can exhibit or store an energy spectrum 1204(1). In various aspects, the energy spectrum 1204(1) can include a respective energy count for each of the t energy (or energy-loss) bins or bands that the charged-particle microscope 302 is configured to monitor. For instance, the energy spectrum 1204(1) can include an energy count 1204(1)(1), which can be a scalar whose magnitude indicates or is otherwise proportional to: how many incident ions belonging to the first energy bin or band struck, impacted, or passed through the specimen 304 at the pixel location 802(m)(1); or how many X-rays belonging to the first energy bin or band were emitted by the specimen 304 from the pixel location 802(m)(1). As another instance, the energy spectrum 1204(1) can include an energy count 1204(1)(t), which can be a scalar whose magnitude indicates or is otherwise proportional to: how many incident ions belonging to the t-th energy bin or band struck, impacted, or passed through the specimen 304 at the pixel location 802(m)(1); or how many X-rays belonging to the t-th energy bin or band were emitted by the specimen 304 from the pixel location 802(m)(1).

As another non-limiting example, whichever one of the plurality of spectral pixels 602 that is masked by or positioned at the pixel location 802(m)(pₘ) can be referred to as a spectral pixel 1202(pₘ). Note that the spectral pixel 1202(pₘ) can exhibit or store an energy spectrum 1204(pₘ). In various aspects, the energy spectrum 1204(pₘ) can include a respective energy count for each of the t energy (or energy-loss) bins or bands that the charged-particle microscope 302 is configured to monitor. For instance, the energy spectrum 1204(pₘ) can include an energy count 1204(pₘ)(1), which can be a scalar whose magnitude indicates or is otherwise proportional to: how many incident ions belonging to the first energy bin or band struck, impacted, or passed through the specimen 304 at the pixel location 802(m)(pₘ); or how many X-rays belonging to the first energy bin or band were emitted by the specimen 304 from the pixel location 802(m)(pₘ). As another instance, the energy spectrum 1204(pₘ) can include an energy count 1204(pₘ)(t), which can be a scalar whose magnitude indicates or is otherwise proportional to: how many incident ions belonging to the t-th energy bin or band struck, impacted, or passed through the specimen 304 at the pixel location 802(m)(pₘ); or how many X-rays belonging to the t-th energy bin or band were emitted by the specimen 304 from the pixel location 802(m)(pₘ).

In various cases, the spectral pixel 1202(1) to the spectral pixel 1202(pₘ) can collectively be referred to as a plurality of masked spectral pixels 1202.

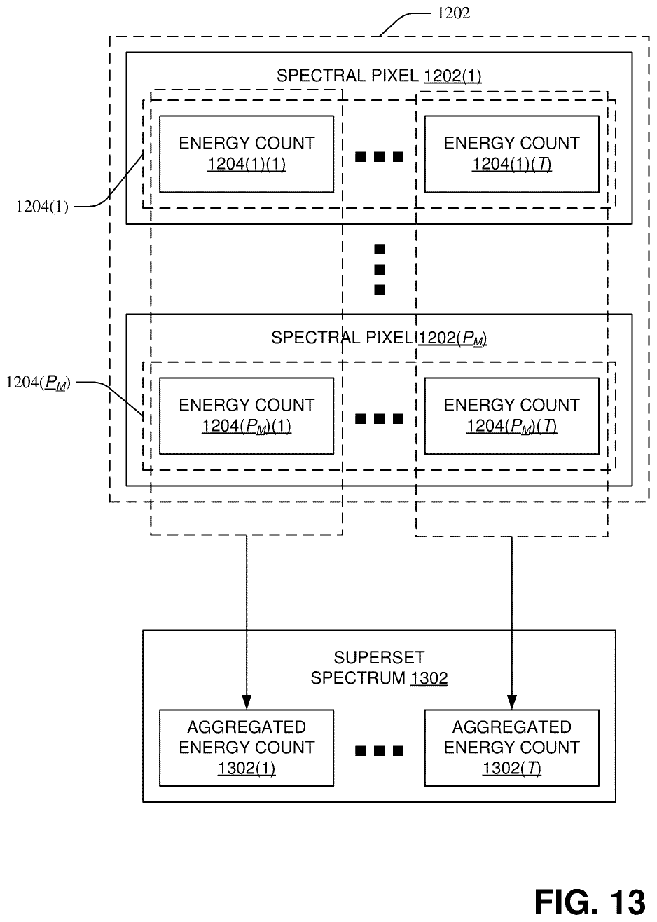

Next, consider FIG. 13. In various aspects, the composition component 318 can generate a superset spectrum 1302, based on the plurality of masked spectral pixels 1202. More specifically, the composition component 318 can accomplish such generation by adding or summing the energy spectra indicated by the plurality of masked spectral pixels 1202 together in energy-bin-wise fashion. As a non-limiting example, the composition component 318 can add together the pₘ total energy counts that are specified by the plurality of masked spectral pixels 1202 for the first energy bin (e.g., can sum together the energy count 1204(1)(1) to the energy count 1204(pₘ)(1)), and such sum can be referred to as an aggregated energy count 1302(1). As another non-limiting example, the composition component 318 can add together the pₘ total energy counts that are specified by the plurality of masked spectral pixels 1202 for the t-th energy bin (e.g., can sum together the energy count 1204(1)(t) to the energy count 1204(pₘ)(t)), and such sum can be referred to as an aggregated energy count 1302(t). The aggregated energy count 1302(1) to the aggregated energy count 1302(t) can be considered as collectively forming the superset spectrum 1302. Note that a signal-to-noise ratio of superset spectrum 1302 can be much lower than that of the energy spectrum of any individual one of the plurality of masked spectral pixels 1202.

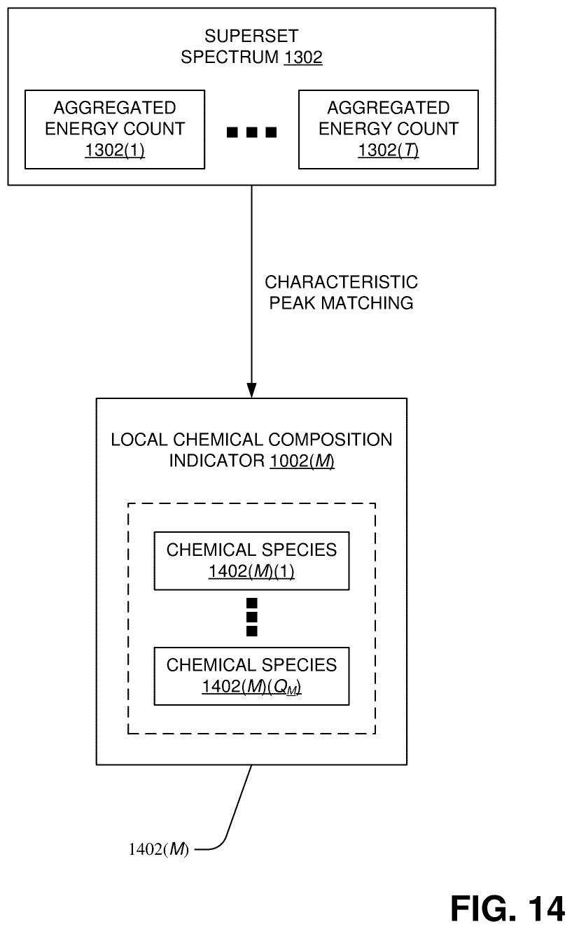

Now, consider FIG. 14. Whichever one of the plurality of local chemical composition indicators 1002 corresponds to the segmented region 802(m) can be referred to as a local chemical composition indicator 1002(m). In various embodiments, the composition component 318 can generate the local chemical composition indicator 1002(m), by performing characteristic peak matching on the superset spectrum 1302.

In particular, the superset spectrum 1302 can be considered as a graph, chart, or plot of aggregated intensity count versus energy (or energy-loss), and such graph, chart, or plot can exhibit any suitable number of spectral peaks (e.g., of aggregated energy counts that are greater than their immediately neighboring aggregated energy counts). For instance, an aggregated energy count 1302(i), for any suitable positive integer 1<i<t can be considered as a spectral peak, if it is greater (possibly by a threshold margin) than an aggregated energy count 1302(i−1) and also greater (possibly by a threshold margin) than an aggregated energy count 1302(i+1).

In any case, the composition component 318 can electronically access any suitable library or database that lists or specifies at what particular energy levels (or energy-losses) various chemical species or elements are known to exhibit characteristic spectral peaks. Accordingly, for each given spectral peak that is exhibited by the superset spectrum 1302, that given spectral peak can be considered as occurring at a particular energy level (or energy-loss), and the composition component 318 can scour the library or database in search of a chemical species or element that is known to exhibit characteristic spectral peaks at that particular energy level (or energy-loss). Once such a chemical species is identified, the composition component 318 can be considered as concluding or determining that the particular spectral peak was caused by the identified chemical species, and so it can be inferred that such identified chemical species is physically present within whatever physical portion of the specimen 304 is illustrated or represented by the segmented region 802(m).

It should be understood or otherwise appreciated that characteristic peak matching is a mere non-limiting example of how the composition component 318 can generate the local chemical composition indicator 1002(m). In other embodiments, the composition component 318 can leverage any other suitable peak identification techniques, such as deep learning peak prediction.

In any case, the local chemical composition indicator 1002(m) can be any suitable electronic data that indicates, specifies, conveys, or otherwise represents the identities of whatever chemical species are detected by the composition component 318's analysis of the superset spectrum 1302, and thus that are determined by the composition component 318 to be physically present within whatever portion of the specimen 304 is illustrated or represented by the segmented region 802(m). As a non-limiting example, suppose that the composition component 318 detects a total of qₘ chemical species by analyzing (e.g., via characteristic peak matching) the superset spectrum 1302, for any suitable positive integer qₘ. In such situation, the local chemical composition indicator 1002(m) can specify a set of chemical species 1402(m), which can have a cardinality of qₘ. That is, the set of chemical species 1402(m) can include a total of qₘ species: a chemical species 1402(m)(1) to a chemical species 1402(m)(qₘ). In various cases, each of the set of chemical species 1402(m) can be the identity or name of a distinct chemical element that the composition component 318 has detected within the segmented region 802(m).

In this way, the composition component 318 can electronically generate a respective local chemical composition indicator for each of the plurality of segmented regions 802, thereby yielding the plurality of local chemical composition indicators 1002.

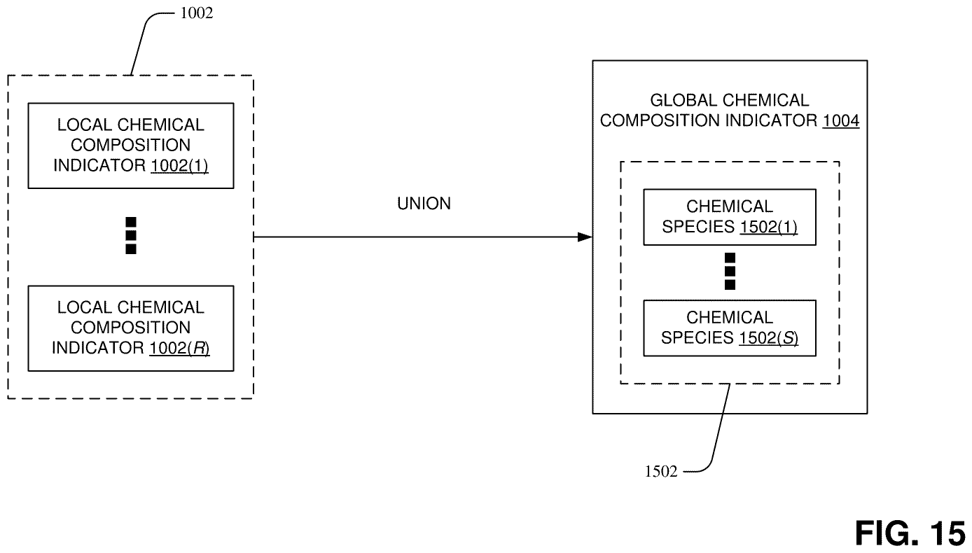

Next, consider FIG. 15. In various embodiments, the composition component 318 can generate the global chemical composition indicator 1004, based on the plurality of local chemical composition indicators 1002. More specifically, the global chemical composition indicator 1004 can be equal to or otherwise based on a union of the plurality of local chemical composition indicators 1002. Thus, the global chemical composition indicator 1004 can be any suitable electronic data that indicates, specifies, conveys, or otherwise represents the identities of all chemical species that have been detected by the composition component 318 in any of the plurality of segmented regions 802, and thus that are determined by the composition component 318 to be physically present somewhere within the specimen 304. As a non-limiting example, the global chemical composition indicator 1004 can specify a set of chemical species 1502, which can have a cardinality of s for any suitable positive integer

$$s \leq {\sum }_{i = 1}^{r} {q}_{r} .$$

That is, the set of chemical species 1502 can include a total of s species: a chemical species 1502(1) to a chemical species 1502(s). In various cases, each of the set of chemical species 1502 can be the identity or name of a distinct or unique chemical element that is listed in at least one of the plurality of local chemical composition indicators 1002.

In various embodiments, the composition component 318 can perform or initiate any suitable electronic actions with respect to the global chemical composition indicator 1004. As a non-limiting example, the composition component 318 can electronically transmit the global chemical composition indicator 1004 to any suitable computing device. As another non-limiting example, the composition component 318 can electronically render the global chemical composition indicator 1004 on any suitable electronical display. As even another non-limiting example, the composition component 318 can electronically generate one or more elemental maps for the specimen 304, based on the global chemical composition indicator 1004 or the plurality of local chemical composition indicators 1002. It should be understood or otherwise appreciated how an elemental map can be formed when given the global chemical composition indicator 1004 or the plurality of local chemical composition indicators 1002.

Note that, because the global chemical composition indicator 1004 can be generated based on the plurality of segmented regions 802, any scarce or sparce chemical species that are present within the specimen 304 can be reliably or confidently specified in the global chemical composition indicator 1004. Indeed, because each of the plurality of segmented regions 802 can contain or be made up of pixel locations that are likely to have the same or similar chemical compositions as each other, some segmented regions will end up representing physical portions of the specimen 304 that are predominantly or mainly composed of plentiful chemical species, whereas other segmented regions will instead end up representing physical portions of the specimen 304 that are predominantly or mainly composed of scarce or sparce chemical species. Because a respective superset spectrum can be created for each segmented region independently (e.g., by ignoring the energy spectra from other segmented regions), the spectral peaks of scarce or sparce chemical species can be clearly visible within the superset spectra of whichever segmented regions are predominantly or mainly composed of those scarce or sparce chemical species. Thus, those scarce or sparce chemical species can be easily detected (e.g., via characteristic peak matching) and thus specified in at least some of the plurality of local chemical composition indicators 1002. Accordingly, the union operation can thereby guarantee that those scarce or sparce chemical species are listed within the global chemical composition indicator 1004.

Note that, in some cases, the plurality of segmented regions 802 can be more accurately generated as n gets larger (although, sufficient or acceptable accuracy can nevertheless be obtained when n=1). After all, each of the set of the non-spectral images 404 can be considered as a unique or varied visualization of the specimen 304 that potentially carries rich or specialized information about the content or structure of the specimen 304. Accordingly, by amassing more of such unique or varied visualizations, the specimen 304 can be segmented into separate regions more reliably or more finely.

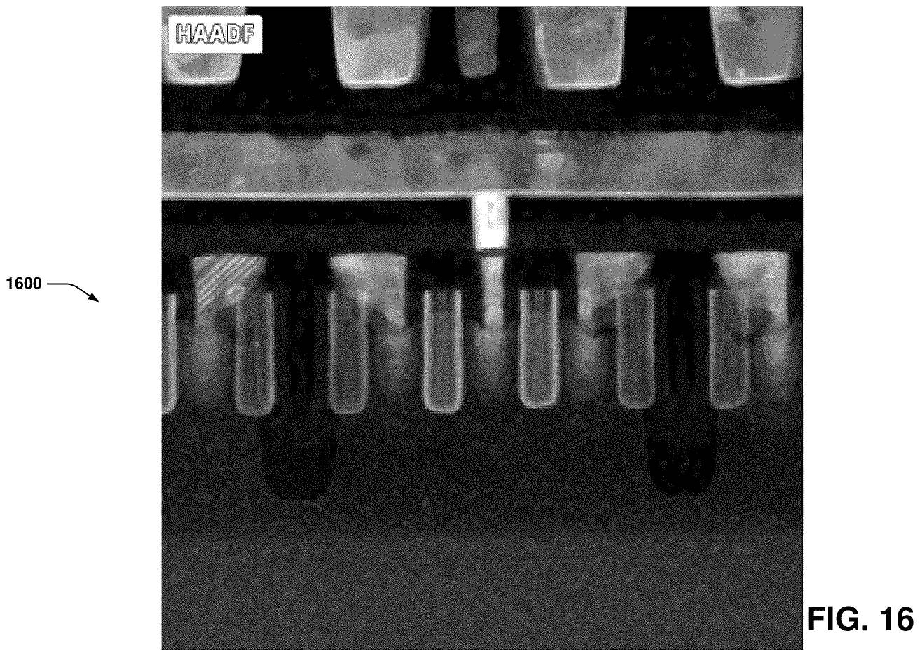

FIGS. 16-24 illustrate example, non-limiting experimental results in accordance with one or more embodiments described herein.

FIG. 16 shows a screenshot of a specimen 1600. The present inventors conducted various experiments in which a spectral image and a non-spectral image of the specimen 1600 were captured and subsequently analyzed, so as to evaluate the chemical composition of the specimen 1600. For validation purposes, the chemical composition of the specimen 1600 was known to include plentiful amounts of silicon (Si) but only scarce amounts of hafnium (Hf).

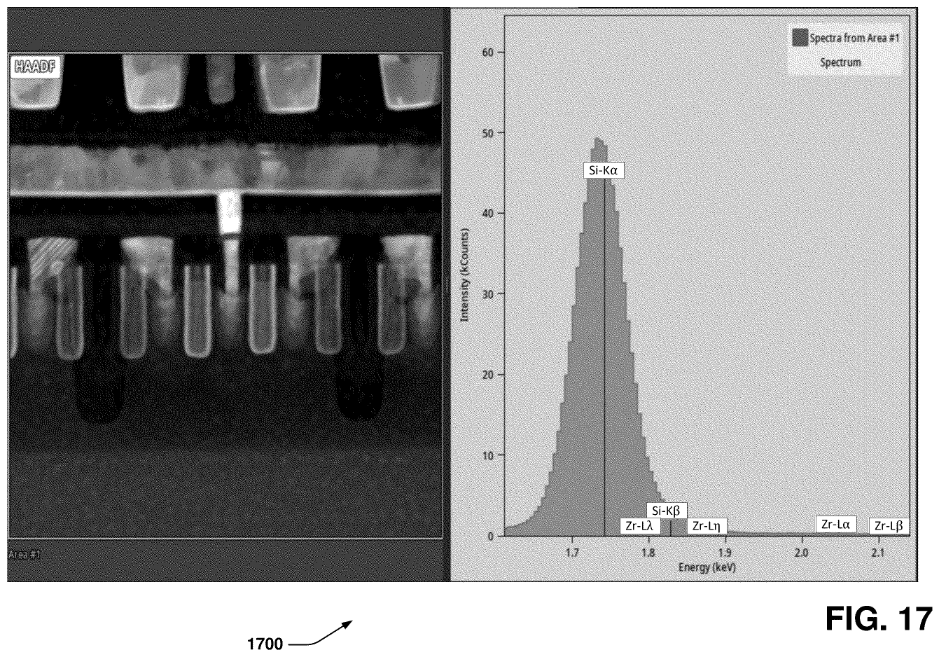

FIG. 17 shows a screenshot 1700, the left-side of which indicates a first bounded area of the specimen 1600, and the right-side of which indicates a first superset energy spectrum corresponding to that first bounded area and on which characteristic peak matching was performed. As shown, that first superset energy spectrum was formed from an entire image area of the specimen 1600 (that is, in accordance with existing techniques). Note how that first superset energy spectrum clearly shows a silicon peak but does not show any hafnium peaks. In other words, the hafnium peaks are hidden or drowned out by the silicon peak.

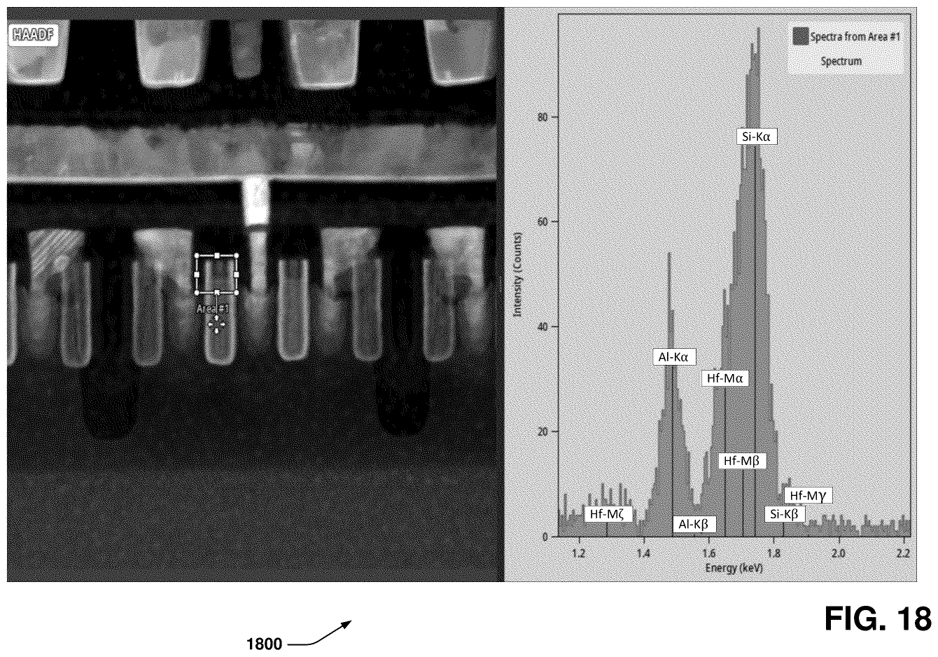

FIG. 18 shows a screenshot 1800, the left-side of which indicates a second bounded area of the specimen 1600, and the right-side of which indicates a second superset energy spectrum corresponding to that second bounded area and on which characteristic peak matching was performed. As shown, that second superset energy spectrum was formed from a small region of the total image area of the specimen 1600 (that is, contrary to existing techniques). Note how that second superset energy spectrum clearly shows not just silicon peaks but also hafnium peaks (as well as peaks of other scarce or sparce elements that were not visible in the screenshot 1700). In other words, this demonstrates that global (e.g., image-wide) entanglements between scarce-element peaks and plentiful-element peaks can be reduced or eliminated by performing characteristic peak matching in a region-wise fashion, rather than on an entirety of a specimen image.

During the experiments conducted by the present inventors, image segmentation was performed on a non-spectral image of the specimen 1600, thereby decomposing that non-spectral image into a plurality of like-appearance regions, and characteristic peak matching was performed on a respective superset energy spectrum for each region.

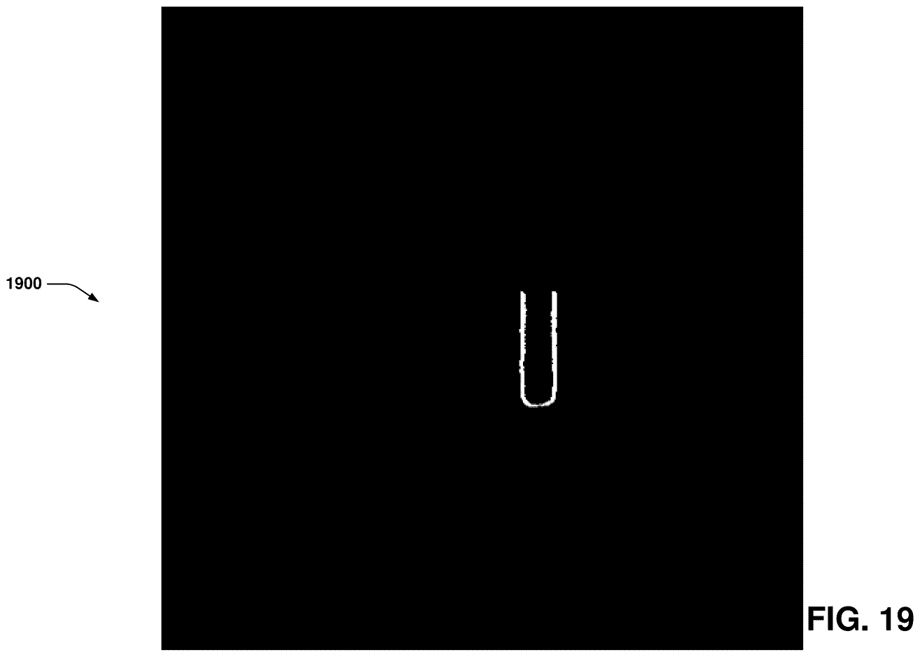

FIG. 19 shows a region 1900 that was identified by such image segmentation.

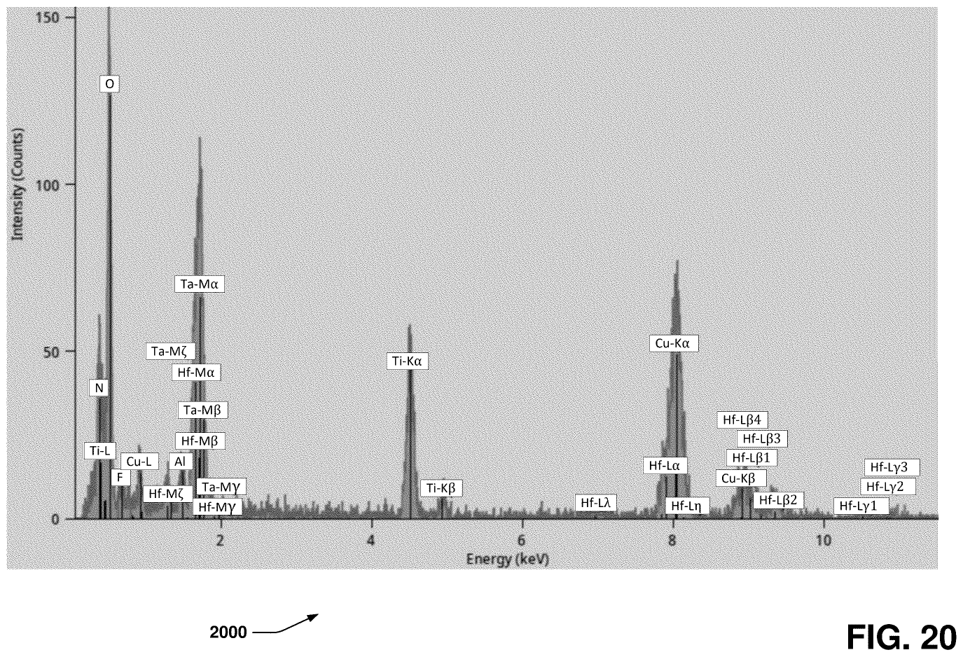

FIG. 20 shows a superset energy spectrum 2000 that was subjected to characteristic peak matching and that was formed by whatever spectral pixels depicting the specimen 1600 were masked by the region 1900.

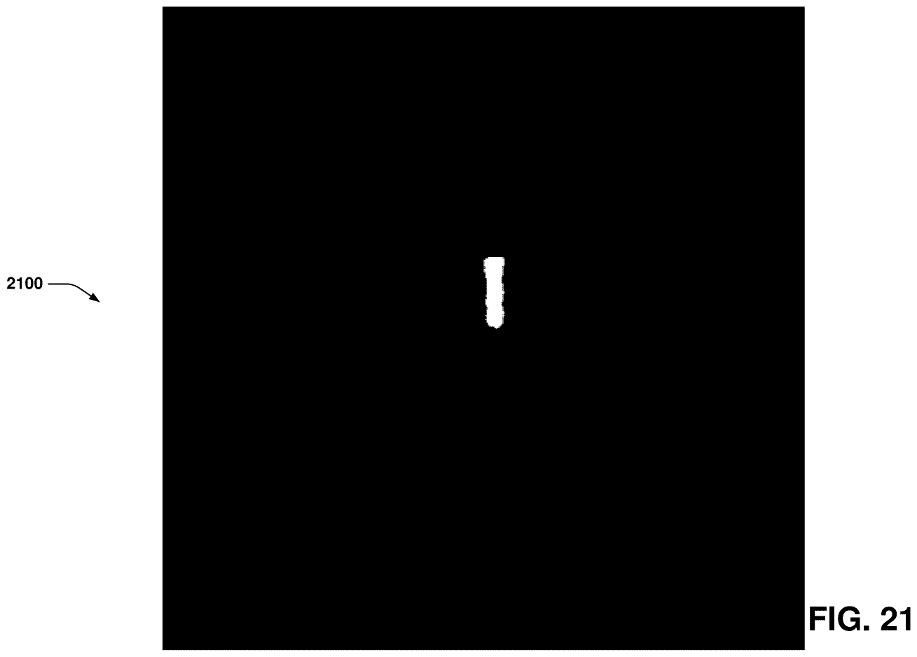

FIG. 21 shows another region 2100 that was identified by image segmentation.

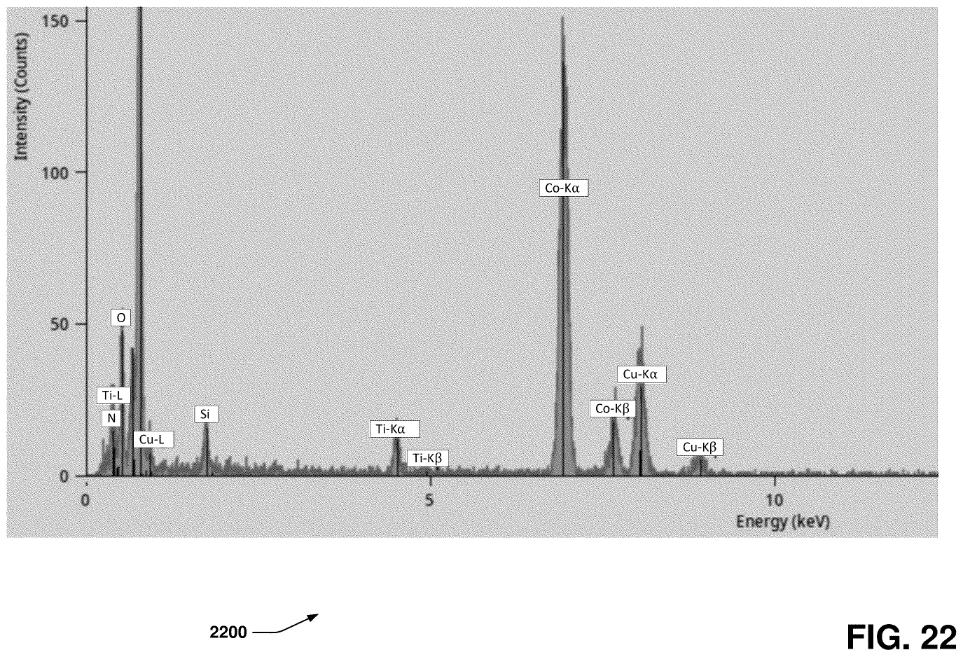

FIG. 22 shows a superset energy spectrum 2200 that was subjected to characteristic peak matching and that was formed by whatever spectral pixels depicting the specimen 1600 were masked by the region 2100.

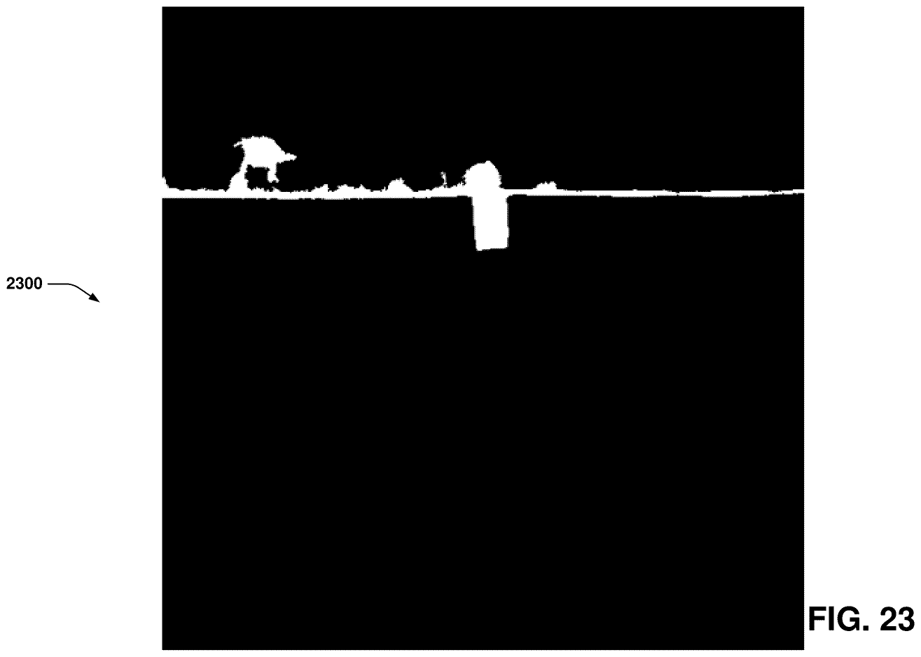

FIG. 23 shows yet another region 2300 that was identified by image segmentation.

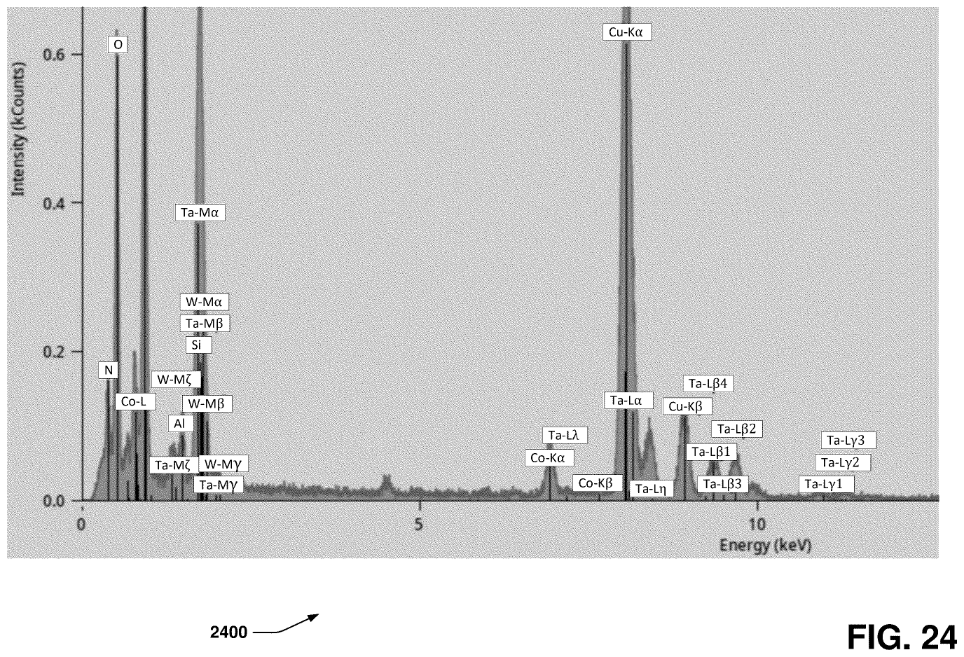

FIG. 24 shows a superset energy spectrum 2400 that was subjected to characteristic peak matching and that was formed by whatever spectral pixels depicting the specimen 1600 were masked by the region 2300.

As shown, the superset energy spectra 2000, 2200, and 2400 indicate very many peaks of sparce or scarce elements that make up the specimen 1600 but whose spectral peaks do not appear in the screenshot 1700. Accordingly, these experimental results demonstrate that various embodiments described herein can confidently or reliably identify scarce elements whose spectral peaks would otherwise be drowned out or hidden by those of plentiful elements. This is a concrete and tangible technical improvement or technical effect in the field of charged-particle microscopy.

Although various embodiments are mainly described herein which involve identification of chemical species or elements that are present within the specimen 304, these are mere non-limiting examples for ease of explanation and illustration. It should be understood and appreciated that, after such chemical species or elements are identified, they can be subsequently quantified by the system 306 in any suitable fashion or via any suitable element quantification techniques. As a non-limiting example, the system 306 can facilitate such quantification by leveraging any suitable calibration curves associated with the charged-particle microscope 302 in a pixel-wise fashion (e.g., by applying such calibration curves to the individual energy spectrum of each individual pixel of the spectral image 402) or in a region-wise fashion (e.g., by applying such calibration curves to the superset energy spectrum of each of the plurality of segmented regions 802). More specifically, when given any energy spectrum (e.g., that of an individual pixel, or that formed by supersetting the energy spectra of whatever pixels belong to an individual segmented region) whose peaks respectively correspond to identified chemical elements, the system 306 can estimate or determine how much of each identified chemical element is present by comparing the intensity or height of whatever peak in that given energy spectrum represents that identified chemical element with the calibration curves. Indeed, such calibration curves can be considered as forming a mapping between: heights of spectral peaks measured or recorded by the charged-particle microscope 302; and elemental quantities (e.g., measured in masses or concentrations). In other words, such calibration curves can be considered as showing or specifying how spectral peak height changes (e.g., increases, or decreases) with elemental quantity. Accordingly, the system 306 can look up in the calibration curves the height of the whatever peak in the given energy spectrum represents the identified chemical element, thereby revealing how much of the identified chemical element is represented by that peak.

In some instances, quantification can be performed on any given energy spectrum after background subtraction is performed on that given energy spectrum: that is, after a background energy signal is identified within and removed from that given energy spectrum. If existing techniques were to be implemented, a background energy signal would be identified directly from the entirety of the spectral image 402. Rather than identifying the background energy signal directly from the entirety of the spectral image 402, various embodiments described herein can instead identify the background energy signal in region-wise fashion. More specifically, the system 306 can, in various aspects, perform any suitable background energy signal identification algorithm or technique individually or independently on each portion of the spectral image 402 that is masked by a respective one of the plurality of segmented regions 802. This can yield a total of r background energy signals (e.g., one background energy signal per segmented region). In various instances, the system 306 can compute an overall background energy signal for the entirety of the spectral image 402 by taking an intersection (not a union) of those r background energy signals. Such intersection can be considered as the background energy signal that is common to or present in all of the plurality of segmented regions 802. That overall background energy signal can be subtracted by the system 306 from any given energy spectrum (e.g., from the individual energy spectrum of an individual pixel of the spectral image 402; from the superset energy spectrum of any segmented region) for which chemical species quantification is desired, and quantification can then be performed. When the overall background energy signal is computed in this intersection-based fashion, it can be considered as representing Bremsstrahlung radiation for EDSM or instead as being tall lower energy excitations or ionizations for EELM.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence (class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

In order to provide additional context for various embodiments described herein, FIG. 25 and the following discussion are intended to provide a brief, general description of a suitable computing environment 2500 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 25, the example environment 2500 for implementing various embodiments of the aspects described herein includes a computer 2502, the computer 2502 including a processing unit 2504, a system memory 2506 and a system bus 2508. The system bus 2508 couples system components including, but not limited to, the system memory 2506 to the processing unit 2504. The processing unit 2504 can be any of various commercially available processors. Dual microprocessors and other multi-processor architectures can also be employed as the processing unit 2504.

The system bus 2508 can be any of several types of bus structure that can further interconnect to a memory bus (with or without a memory controller), a peripheral bus, and a local bus using any of a variety of commercially available bus architectures. The system memory 2506 includes ROM 2510 and RAM 2512. A basic input/output system (BIOS) can be stored in a non-volatile memory such as ROM, erasable programmable read only memory (EPROM), EEPROM, which BIOS contains the basic routines that help to transfer information between elements within the computer 2502, such as during startup. The RAM 2512 can also include a high-speed RAM such as static RAM for caching data.

The computer 2502 further includes an internal hard disk drive (HDD) 2514 (e.g., EIDE, SATA), one or more external storage devices 2516 (e.g., a magnetic floppy disk drive (FDD) 2516, a memory stick or flash drive reader, a memory card reader, etc.) and a drive 2520, e.g., such as a solid state drive, an optical disk drive, which can read or write from a disk 2522, such as a CD-ROM disc, a DVD, a BD, etc. Alternatively, where a solid state drive is involved, disk 2522 would not be included, unless separate. While the internal HDD 2514 is illustrated as located within the computer 2502, the internal HDD 2514 can also be configured for external use in a suitable chassis (not shown). Additionally, while not shown in environment 2500, a solid state drive (SSD) could be used in addition to, or in place of, an HDD 2514. The HDD 2514, external storage device(s) 2516 and drive 2520 can be connected to the system bus 2508 by an HDD interface 2524, an external storage interface 2526 and a drive interface 2528, respectively. The interface 2524 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2502, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2512, including an operating system 2530, one or more application programs 2532, other program modules 2534 and program data 2536. All or portions of the operating system, applications, modules, or data can also be cached in the RAM 2512. The systems and methods described herein can be implemented utilizing various commercially available operating systems or combinations of operating systems.

Computer 2502 can optionally comprise emulation technologies. For example, a hypervisor (not shown) or other intermediary can emulate a hardware environment for operating system 2530, and the emulated hardware can optionally be different from the hardware illustrated in FIG. 25. In such an embodiment, operating system 2530 can comprise one virtual machine (VM) of multiple VMs hosted at computer 2502. Furthermore, operating system 2530 can provide runtime environments, such as the Java runtime environment or the .NET framework, for applications 2532. Runtime environments are consistent execution environments that allow applications 2532 to run on any operating system that includes the runtime environment. Similarly, operating system 2530 can support containers, and applications 2532 can be in the form of containers, which are lightweight, standalone, executable packages of software that include, e.g., code, runtime, system tools, system libraries and settings for an application.

Further, computer 2502 can be enable with a security module, such as a trusted processing module (TPM). For instance with a TPM, boot components hash next in time boot components, and wait for a match of results to secured values, before loading a next boot component. This process can take place at any layer in the code execution stack of computer 2502, e.g., applied at the application execution level or at the operating system (OS) kernel level, thereby enabling security at any level of code execution.

A user can enter commands and information into the computer 2502 through one or more wired/wireless input devices, e.g., a keyboard 2538, a touch screen 2540, and a pointing device, such as a mouse 2542. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2504 through an input device interface 2544 that can be coupled to the system bus 2508, but can be connected by other interfaces, such as a parallel port, an IEEE 1394 serial port, a game port, a USB port, an IR interface, a BLUETOOTH® interface, etc.

A monitor 2546 or other type of display device can be also connected to the system bus 2508 via an interface, such as a video adapter 2548. In addition to the monitor 2546, a computer typically includes other peripheral output devices (not shown), such as speakers, printers, etc.

The computer 2502 can operate in a networked environment using logical connections via wired or wireless communications to one or more remote computers, such as a remote computer(s) 2550. The remote computer(s) 2550 can be a workstation, a server computer, a router, a personal computer, portable computer, microprocessor-based entertainment appliance, a peer device or other common network node, and typically includes many or all of the elements described relative to the computer 2502, although, for purposes of brevity, only a memory/storage device 2552 is illustrated. The logical connections depicted include wired/wireless connectivity to a local area network (LAN) 2554 or larger networks, e.g., a wide area network (WAN) 2556. Such LAN and WAN networking environments are commonplace in offices and companies, and facilitate enterprise-wide computer networks, such as intranets, all of which can connect to a global communications network, e.g., the Internet.

When used in a LAN networking environment, the computer 2502 can be connected to the local network 2554 through a wired or wireless communication network interface or adapter 2558. The adapter 2558 can facilitate wired or wireless communication to the LAN 2554, which can also include a wireless access point (AP) disposed thereon for communicating with the adapter 2558 in a wireless mode.

When used in a WAN networking environment, the computer 2502 can include a modem 2560 or can be connected to a communications server on the WAN 2556 via other means for establishing communications over the WAN 2556, such as by way of the Internet. The modem 2560, which can be internal or external and a wired or wireless device, can be connected to the system bus 2508 via the input device interface 2544. In a networked environment, program modules depicted relative to the computer 2502 or portions thereof, can be stored in the remote memory/storage device 2552. It will be appreciated that the network connections shown are example and other means of establishing a communications link between the computers can be used.

When used in either a LAN or WAN networking environment, the computer 2502 can access cloud storage systems or other network-based storage systems in addition to, or in place of, external storage devices 2516 as described above, such as but not limited to a network virtual machine providing one or more aspects of storage or processing of information. Generally, a connection between the computer 2502 and a cloud storage system can be established over a LAN 2554 or WAN 2556 e.g., by the adapter 2558 or modem 2560, respectively. Upon connecting the computer 2502 to an associated cloud storage system, the external storage interface 2526 can, with the aid of the adapter 2558 or modem 2560, manage storage provided by the cloud storage system as it would other types of external storage. For instance, the external storage interface 2526 can be configured to provide access to cloud storage sources as if those sources were physically connected to the computer 2502.

The computer 2502 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

FIG. 26 is a schematic block diagram of a sample computing environment 2600 with which the disclosed subject matter can interact. The sample computing environment 2600 includes one or more client(s) 2610. The client(s) 2610 can be hardware or software (e.g., threads, processes, computing devices). The sample computing environment 2600 also includes one or more server(s) 2630. The server(s) 2630 can also be hardware or software (e.g., threads, processes, computing devices). The servers 2630 can house threads to perform transformations by employing one or more embodiments as described herein, for example. One possible communication between a client 2610 and a server 2630 can be in the form of a data packet adapted to be transmitted between two or more computer processes. The sample computing environment 2600 includes a communication framework 2650 that can be employed to facilitate communications between the client(s) 2610 and the server(s) 2630. The client(s) 2610 are operably connected to one or more client data store(s) 2620 that can be employed to store information local to the client(s) 2610. Similarly, the server(s) 2630 are operably connected to one or more server data store(s) 2640 that can be employed to store information local to the servers 2630.

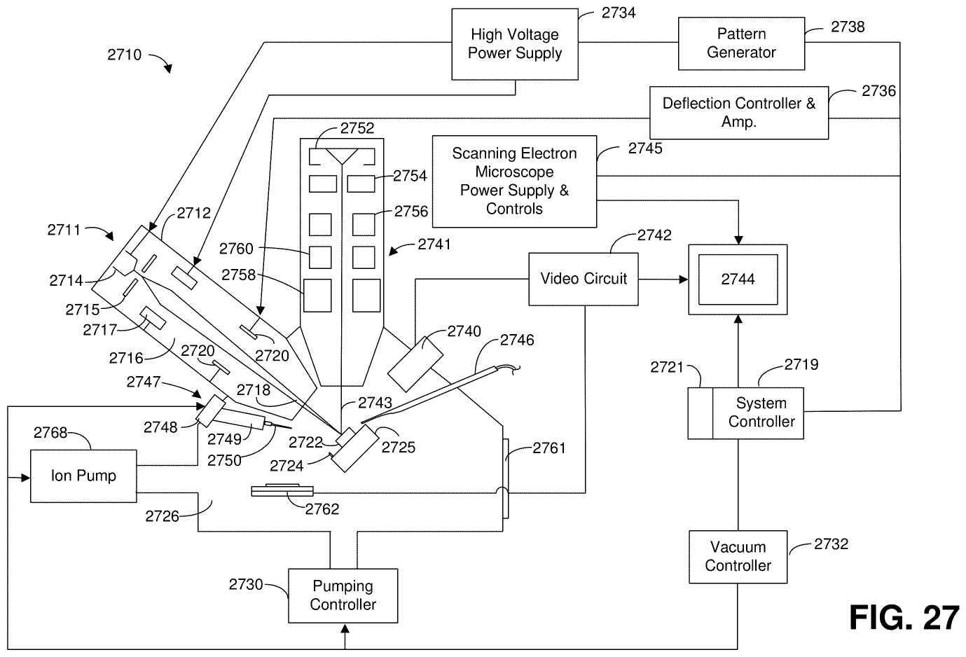

An example, non-limiting apparatus for performing various embodiments described herein is shown in FIG. 27. FIG. 27 illustrates a non-limiting example of a dual beam system 2710 with a vertically mounted scanning electron microscope (SEM) column and a focused ion beam (FIB) column mounted at an angle of approximately 52 degrees from the vertical. Such dual beam systems are commercially available, for example, from FEI Company, Hillsboro, Oregon, the assignee of the present application. While FIG. 27 shows an example of suitable microscopy hardware with which various embodiments described herein can be implemented, it is to be appreciated that such microscopy hardware is non-limiting. In other words, various embodiments described herein can be implemented in conjunction with any other suitable types of microscopy hardware. The dual beam system 2710 is a non-limiting example of the charged-particle microscope 302 or of any other scientific instruments discussed above.

A scanning electron microscope 2741, along with a power supply and control unit 2745, can be provided with the dual beam system 2710. An electron beam 2743 can be emitted from a cathode 2752 by applying voltage between the cathode 2752 and an anode 2754. The electron beam 2743 can be focused to a fine spot by means of a condensing lens 2756 and an objective lens 2758. The electron beam 2743 can be scanned two-dimensionally on any suitable specimen by means of a deflection coil 2760. Operation of the condensing lens 2756, the objective lens 2758, or the deflection coil 2760 can be controlled by the power supply and control unit 2745.

The electron beam 2743 can be focused onto a substrate 2722, which can be on a movable X-Y stage 2725 within a lower chamber 2726. When the electrons in the electron beam 2743 strike the substrate 2722, secondary electrons can be emitted. These secondary electrons can be detected by a secondary electron detector 2740 as discussed below. A scanning transmission electron microscopy (STEM) detector 2762, located beneath a transmission electron microscopy (TEM) sample holder 2724 and the movable X-Y stage 2725, can collect electrons that are transmitted through the sample mounted on the TEM sample holder 2724 as discussed above.

The dual beam system 2710 can also include a focused ion beam (FIB) system 2711 which can comprise an evacuated chamber having an upper neck portion 2712 within which can be located an ion source 2714 and a focusing column 2716 including extractor electrodes and an electrostatic optical system. The axis of the focusing column 2716 can be tilted 52 degrees (or any other suitable angular displacement) from the axis of the electron column. The ion column 2712 can include an ion source 2714, an extraction electrode 2715, a focusing element 2717, deflection elements 2720, and a focused ion beam 2718. The focused ion beam 2718 can pass from the ion source 2714 through the focusing column 2716 and between electrostatic deflection means schematically indicated at numeral 2720 toward the substrate 2722, which can comprise, for example, a semiconductor device positioned on the movable X-Y stage 2725 within the lower chamber 2726.

The movable X-Y stage 2725 can move in a horizontal plane (along X and Y axes) and vertically (along Z axis). The movable X-Y stage 2725 can tilt approximately sixty (60) degrees and rotate about the Z axis. In some embodiments, a separate TEM sample stage (not shown) can be used. Such a TEM sample stage can be moveable in the X, Y, and Z axes. A door 2761 can be opened for inserting the substrate 2722 onto the movable X-Y stage 2725 or also for servicing an internal gas supply reservoir, if one is used. The door 2761 can be interlocked so that it cannot be opened if the system is under vacuum.

An ion pump 2768 can be employed for evacuating the neck portion 2712. The chamber 2726 can be evacuated with a turbomolecular and mechanical pumping system 2730 under the control of a vacuum controller 2732. Such vacuum system can provide within the chamber 2726 a vacuum of between approximately 1×10⁻⁷ Torr and 5×10⁻⁴ Torr. If an etch assisting, an etch retarding gas, or a deposition precursor gas is used, the chamber background pressure may rise, typically to about 1×10⁻⁵ Torr.

A high voltage power supply 2734 can provide an appropriate acceleration voltage to electrodes in the focusing column 2716 for energizing and the focused ion beam 2718. When it strikes the substrate 2722, material can be sputtered (that is, physically ejected) from the sample. Alternatively, the focused ion beam 2718 can decompose a precursor gas to deposit a material.

The high voltage power supply 2734 can be connected to the ion source 2714 (which can be a liquid metal ion source) as well as to appropriate electrodes in the ion beam focusing column 2716 for forming an approximately 1 keV to 60 keV ion beam 2718 and directing the same toward a sample. A deflection controller and amplifier 2736, operated in accordance with a prescribed pattern provided by a pattern generator 2738, can be coupled to the deflection elements 2720 (which can be deflection plates) whereby the focused ion beam 2718 may be controlled manually or automatically to trace out a corresponding pattern on the upper surface of the substrate 2722. In some systems, the deflection elements 2720 can be placed before the final lens. Beam blanking electrodes (not shown) within the ion beam focusing column 2716 can cause the focused ion beam 2718 to impact onto a blanking aperture (not shown) instead of the substrate 2722 when a blanking controller (not shown) applies a blanking voltage to a blanking electrode.

The ion source 2714 can provide a metal ion beam of gallium, for example. In other examples, the ion source 2714 may be a plasma ion source that extracts ions from a generated plasma. The source can be capable of being focused into a sub one-tenth micrometer wide beam at the substrate 2722 for either modifying the substrate 2722 by ion milling, enhanced etch, material deposition, or for the purpose of imaging the substrate 2722.

A charged particle detector 2740, such as an Everhart Thornley or multi-channel plate, used for detecting secondary ion or electron emission can be connected to a video circuit 2742 that can supply drive signals to a video monitor 2744 and receive deflection signals from a system controller 2719. The location of the charged particle detector 2740 within the lower chamber 2726 can vary in different embodiments. For example, the charged particle detector 2740 can be coaxial with the ion beam and include a hole for allowing the ion beam to pass. In other embodiments, secondary particles can be collected through a final lens and then diverted off axis for collection.

A micromanipulator 2747 can precisely move objects within the vacuum chamber. The micromanipulator 2747 may comprise precision electric motors 2748 positioned outside the vacuum chamber to provide X, Y, Z, and theta control of a portion 2749 positioned within the vacuum chamber. The micromanipulator 2747 can be fitted with different end effectors for manipulating small objects. In various embodiments described herein, the end effector can be a thin probe 2750.

A gas delivery system 2746 can extend into the lower chamber 2726 for introducing and directing a gaseous vapor toward the substrate 2722. U.S. Pat. No. 5,851,413 to Casella et al. for “Gas Delivery Systems for Particle Beam Processing,” assigned to the assignee of the present invention, describes a suitable gas delivery system 2746. Another gas delivery system is described in U.S. Pat. No. 5,435,850 to Rasmussen for a “Gas Injection System,” also assigned to the assignee of the present invention. For example, iodine can be delivered to enhance etching, or a metal organic compound can be delivered to deposit a metal.

The system controller 2719 can control the operations of the various parts of the dual beam system 2710. Through the system controller 2719, a user can cause the focused ion beam 2718 or the electron beam 2743 to be scanned in a desired manner through commands entered into any suitable user interface (not shown). Alternatively, the system controller 2719 may control the dual beam system 2710 in accordance with programmed instructions stored in a memory 2721. In various embodiments, any of the one or more software components 311 can be implemented in or otherwise executed by the system controller 2719.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For ease of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various non-limiting aspects are described in the following examples.

Example 1: A system can comprise: a processor that executes computer-executable components stored in a non-transitory computer-readable memory, wherein the computer-executable components can comprise: an access component that can access a spectral image and at least one non-spectral image of a specimen captured by a charged-particle microscope; and a composition component that can generate a global chemical composition indicator for the specimen, based on a union of a plurality of local chemical composition indicators derived from the spectral image and from the at least one non-spectral image.

Example 2: The system of any preceding example can be implemented, wherein the spectral image and the at least one non-spectral image can be aligned with each other, such that pixels of the at least one non-spectral image have a one-to-one correspondence with respective pixels of the spectral image.

Example 3: The system of any preceding example can be implemented, wherein the computer-executable components comprise: a segmentation component that can apply image segmentation to the at least one non-spectral image, thereby decomposing the at least one non-spectral image into a plurality of segmented regions.

Example 4: The system of any preceding example can be implemented, wherein a first local chemical composition indicator in the plurality of local chemical composition indicators can correspond to a first segmented region in the plurality of segmented regions, and wherein the composition component can generate the first local chemical composition indicator based on applying characteristic peak matching to energy spectra respectively indicated by pixels of the spectral image that are masked by the first segmented region and without regard to energy spectra respectively indicated by pixels of the spectral image that are not masked by the first segmented region.

Example 5: The system of any preceding example can be implemented, wherein the composition component can apply the characteristic peak matching to a superset spectrum collectively formed by the energy spectra respectively indicated by the pixels of the spectral image that are masked by the first segmented region.

Example 6: The system of any preceding example can be implemented, wherein the at least one non-spectral image can comprise a plurality of non-spectral images, each of which can depict a respective visualization of the specimen.

Example 7: The system of any preceding example can be implemented, wherein the charged-particle microscope can be an electron energy loss microscope or an energy dispersive X-ray microscope.

Example 8: The system of any preceding example can be implemented, wherein the specimen can be a semiconductor wafer on which or in which electronic circuitry is fabricated.

Example 9: The system of any preceding example can be implemented, wherein the global chemical composition indicator can indicate identities of chemical elements present in the specimen.

In various embodiments, any combination or combinations of examples 1-9 can be implemented.

Example 10: A computer-implemented method can comprise: accessing, by a device operatively coupled to a processor, a spectral image and at least one non-spectral image of a specimen captured by a charged-particle microscope; and generating, by the device, a global chemical composition indicator for the specimen, based on a union of a plurality of local chemical composition indicators derived from the spectral image and from the at least one non-spectral image.

Example 11: The computer-implemented method of any preceding example can be implemented, wherein the spectral image and the at least one non-spectral image can be aligned with each other, such that pixels of the at least one non-spectral image have a one-to-one correspondence with respective pixels of the spectral image.

Example 12: The computer-implemented method of any preceding example can be implemented, further comprising: applying, by the device, image segmentation to the at least one non-spectral image, thereby decomposing the at least one non-spectral image into a plurality of segmented regions.

Example 13: The computer-implemented method of any preceding example can be implemented, wherein a first local chemical composition indicator in the plurality of local chemical composition indicators can correspond to a first segmented region in the plurality of segmented regions, and wherein the device can generate the first local chemical composition indicator based on applying characteristic peak matching to energy spectra respectively indicated by pixels of the spectral image that are masked by the first segmented region and without regard to energy spectra respectively indicated by pixels of the spectral image that are not masked by the first segmented region.

Example 14: The computer-implemented method of any preceding example can be implemented, wherein the device can apply the characteristic peak matching to a superset spectrum collectively formed by the energy spectra respectively indicated by the pixels of the spectral image that are masked by the first segmented region.

Example 15: The computer-implemented method of any preceding example can be implemented, wherein the at least one non-spectral image can comprise a plurality of non-spectral images, each of which can depict a respective visualization of the specimen.

Example 16: The computer-implemented method of any preceding example can be implemented, wherein the charged-particle microscope can be an electron energy loss microscope or an energy dispersive X-ray microscope.

Example 17: The computer-implemented method of any preceding example can be implemented, wherein the specimen can be a semiconductor wafer on which or in which electronic circuitry is fabricated.

Example 18: The computer-implemented method of any preceding example can be implemented, wherein the global chemical composition indicator can indicate identities of chemical elements present in the specimen.

In various embodiments, any combination or combinations of examples 10-18 can be implemented.

Example 19: A computer program product for facilitating disentanglement of overlapping global peaks in a spectral image via union of local peaks from image segmentation can comprise a non-transitory computer-readable memory having program instructions embodied therewith. In various aspects, the program instructions can be executable by a processor to cause the processor to: cause a charged-particle microscope to scan a specimen, thereby yielding a spectral image of the specimen and at least one non-spectral image of the specimen; apply image segmentation to the at least one non-spectral image, thereby decomposing the at least one non-spectral image into a plurality of segmented regions; apply, for each of the plurality of segmented regions, characteristic peak matching to energy spectra respectively indicated by pixels of the spectral image that are masked by that segmented region, thereby yielding a plurality of local chemical composition indicators; and generate a global chemical composition indicator for the specimen, by taking a union of the plurality of local chemical composition indicators.

Example 20: The computer program product of any preceding example can be implemented, wherein the charged-particle microscope can be an electron energy loss microscope or an energy dispersive X-ray microscope.

In various embodiments, any combination or combinations of examples 19-20 can be implemented.

In various embodiments, any combination or combinations of examples 1-20 can be implemented.

What is claimed is:

1. A system, comprising:
a processor that executes computer-executable components stored in a non-transitory computer-readable memory, wherein the computer-executable components comprise:
an access component that accesses a spectral image and at least one non-spectral image of a specimen captured by a charged-particle microscope; and
a composition component that generates a global chemical composition indicator for the specimen, based on a union of a plurality of local chemical composition indicators derived from the spectral image and from the at least one non-spectral image.

2. The system of claim 1, wherein the spectral image and the at least one non-spectral image are aligned with each other, such that pixels of the at least one non-spectral image have a one-to-one correspondence with respective pixels of the spectral image.

3. The system of claim 2, wherein the computer-executable components comprise:
a segmentation component that applies image segmentation to the at least one non-spectral image, thereby decomposing the at least one non-spectral image into a plurality of segmented regions.

4. The system of claim 3, wherein a first local chemical composition indicator in the plurality of local chemical composition indicators corresponds to a first segmented region in the plurality of segmented regions, and wherein the composition component generates the first local chemical composition indicator based on applying characteristic peak matching to energy spectra respectively indicated by pixels of the spectral image that are masked by the first segmented region and without regard to energy spectra respectively indicated by pixels of the spectral image that are not masked by the first segmented region.

5. The system of claim 4, wherein the composition component applies the characteristic peak matching to a superset spectrum collectively formed by the energy spectra respectively indicated by the pixels of the spectral image that are masked by the first segmented region.

6. The system of claim 1, wherein the at least one non-spectral image comprises a plurality of non-spectral images, each of which depicts a respective visualization of the specimen.

7. The system of claim 1, wherein the charged-particle microscope is an electron energy loss microscope or an energy dispersive X-ray microscope.

8. The system of claim 1, wherein the specimen is a semiconductor wafer on which or in which electronic circuitry is fabricated.

9. The system of claim 1, wherein the global chemical composition indicator indicates identities of chemical elements present in the specimen.

10. A computer-implemented method, comprising:
accessing, by a device operatively coupled to a processor, a spectral image and at least one non-spectral image of a specimen captured by a charged-particle microscope; and
generating, by the device, a global chemical composition indicator for the specimen, based on a union of a plurality of local chemical composition indicators derived from the spectral image and from the at least one non-spectral image.

11. The computer-implemented method of claim 10, wherein the spectral image and the at least one non-spectral image are aligned with each other, such that pixels of the at least one non-spectral image have a one-to-one correspondence with respective pixels of the spectral image.

12. The computer-implemented method of claim 11, further comprising:
applying, by the device, image segmentation to the at least one non-spectral image, thereby decomposing the at least one non-spectral image into a plurality of segmented regions.

13. The computer-implemented method of claim 12, wherein a first local chemical composition indicator in the plurality of local chemical composition indicators corresponds to a first segmented region in the plurality of segmented regions, and wherein the device generates the first local chemical composition indicator based on applying characteristic peak matching to energy spectra respectively indicated by pixels of the spectral image that are masked by the first segmented region and without regard to energy spectra respectively indicated by pixels of the spectral image that are not masked by the first segmented region.

14. The computer-implemented method of claim 13, wherein the device applies the characteristic peak matching to a superset spectrum collectively formed by the energy spectra respectively indicated by the pixels of the spectral image that are masked by the first segmented region.

15. The computer-implemented method of claim 10, wherein the at least one non-spectral image comprises a plurality of non-spectral images, each of which depicts a respective visualization of the specimen.

16. The computer-implemented method of claim 10, wherein the charged-particle microscope is an electron energy loss microscope or an energy dispersive X-ray microscope.

17. The computer-implemented method of claim 10, wherein the specimen is a semiconductor wafer on which or in which electronic circuitry is fabricated.

18. The computer-implemented method of claim 10, wherein the global chemical composition indicator indicates identities of chemical elements present in the specimen.

19. A computer program product for facilitating disentanglement of overlapping global peaks in a spectral image via union of local peaks from image segmentation, the computer program product comprising a non-transitory computer-readable memory having program instructions embodied therewith, the program instructions executable by a processor to cause the processor to:
cause a charged-particle microscope to scan a specimen, thereby yielding a spectral image of the specimen and at least one non-spectral image of the specimen;
apply image segmentation to the at least one non-spectral image, thereby decomposing the at least one non-spectral image into a plurality of segmented regions;
apply, for each of the plurality of segmented regions, characteristic peak matching to energy spectra respectively indicated by pixels of the spectral image that are masked by that segmented region, thereby yielding a plurality of local chemical composition indicators; and
generate a global chemical composition indicator for the specimen, by taking a union of the plurality of local chemical composition indicators.

20. The computer program product of claim 19, wherein the charged-particle microscope is an electron energy loss microscope or an energy dispersive X-ray microscope.
